(19) United States
(12) Patent Application Publication
(10) Pub. No.: US 2013/0041696 A1
(43) Pub. Date: Feb. 14, 2013

(54) TRAVEL DISCOVERY AND RECOMMENDATION METHOD AND SYSTEM

(71) Applicant: Postrel Richard, Miami Beach, FL (US)

(72) Inventor: Postrel Richard, Miami Beach, FL (US)

(21) Appl. No.: 13/206,577

(22) Filed: Aug. 10, 2011

(51) Int. Cl. G06Q 10/02

(52) U.S. Cl. 705/5

(57) ABSTRACT

A suggestive intelligent recommendation engine enabling customers to discover new travel and entertainment opportunities tied to value enhanced offers from travel service providers through a static or dynamic bid/offer system internal to a travel reservation system. The customer inputs various travel criteria and preferences, and a computer generates travel predictors. A series of master travel itineraries are generated, which include various travel segments for each master itinerary. Each segment includes a number of options for the customer to review, consider, select and delete, and request revisions. The master itineraries are shuffled on an iterative based on the selections of the customer from the segments of the master itinerary. Prices for each selected option are requested form various travel service providers, which are then discounted prior to presentation to the customer. A proposed itinerary payment solution is generated, which may include a monetary portion and a promotional portion.

### TECHNICAL FIELD

This invention relates to travel reservation and bookings systems, and in particular to a travel discovery and reservation system that implements a suggestive intelligent recommendation engine (“SIRE”) that enables customers (including end-users and travel agents as intermediary users on behalf of the end-user) to discover new travel and entertainment opportunities which are tied to value enhanced offers from various travel service providers through a static (table-driven) or dynamic (real-time interactive) bid/offer system that is internal to a travel reservation system with which the customer interacts. This provides for discovery and recommendation of travel and entertainment opportunities on an iterative basis based upon an ever-increasing understanding and knowledge of the customer which may be regulated and controlled by the customer during the process.

### BACKGROUND OF THE INVENTION

Online travel reservation systems exist that allow customers to make requests for airlines flights to specified destinations, book hotels at those destinations, rent cars if needed, etc. In these systems, the customer must know exactly where he would like to go and designate which airports he would like to use. Thus, existing travel reservation systems do not provide for intelligent analysis of a customer's travel desires and preferences, or for making recommendations for travel based on this analysis. Similarly, prior art travel systems do not provide the ability for a customer to specify travel criteria that may be very broad or specific as desired, and for the ability to provide that customers with proposed travel itineraries having various travel segments that may be accepted or rejected by the customer. The present invention addresses these shortcomings of the prior art as further described herein.

### SUMMARY OF THE INVENTION

The present invention is a suggestive intelligent recommendation engine (“SIRE”) that enables customers (including end-users and travel agents as intermediary users on behalf of the end-user) to discover new travel and entertainment opportunities which are tied to value enhanced offers from various travel service providers through a static (table-driven) or dynamic (real-time interactive) bid/offer system that is internal to a travel reservation system with which the customer interacts. This provides for discovery and recommendation of travel and entertainment opportunities on an iterative basis based upon an ever-increasing understanding and knowledge of the customer which may be regulated and controlled by the customer during the process.

Thus, as provided herein the present invention is a computer-implemented method of a travel discovery and reservation computer generating a series of proposed travel segments which may be automatically or manually assembled as master travel itineraries. The master travel itineraries include various travel categories that each provide various segments that are proposed for a customer from which to make a selection or series of selections. Each master travel itinerary will have any number of segments, each of which is associated with one or more travel categories that make up the master itinerary. The travel categories are broad and typically include transportation, lodging, meals and events. Most travel itineraries will include at least one segment from each category, and some itineraries (such as cruises) may combine segments from different categories. Segments are more specific means of fulfilling a required travel category and give the customer several choices to make from various travel service providers who provide offers on request by the travel discovery and reservation computer. Transportation segments may include airline flights, limousine rides, and car rentals. Lodging segments may include hotel stays, motel stays, and private home lodging. Meal segments may include breakfasts, lunches, dinners, brunches, etc. Event segments may include sporting event tickets, ski lift tickets, spa reservations, theater packages, etc.

For example, the master itinerary may include a transportation category with an airline flight segment that provides an airline flight from the origin to the destination and a car rental segment that provides the customer with a rental car for part or all of the trip, a lodging category with a hotel room segment that provides the customer with a hotel room for the duration of the trip, a meal category with an all-inclusive meal segment that provides all-inclusive meals for the trip, and an event category with an theater segment that provides the customer with theater show tickets and a spa segment that provides the customer with a spa reservation.

First, the customer inputs a set of travel criteria from a list or set of list provided by a series of templates into one or more web pages provided by the travel discovery and reservation computer to the customer's computer. The information may also be provided through a list of questions and queries which the customer responds to for each selected criteria. The travel criteria enables the customer to specify many things such as the type of travel desired, the cost of the travel desired, the destination desired, and types of meals, events and entertainment desired. The travel criteria entered may be very general (e.g. travel sometime next summer in South America), or it may be as specific (e.g. travel from Aug. 1-8, 2012 in Brazil), as desired by the customer. The criteria provided by the customer computer are controllable by an associated input control provided by the travel discovery and reservation computer to the customer computer. For example, the input controls may include a slider control, a group of radio buttons, and/or check boxes. The travel criteria may include a budget amount input specifying the amount of money the customer is willing to pay for the master travel itinerary. The travel criteria may also include a desired travel time when the customer desires to travel, which could specify a desired beginning date and a desired end date, a desired season, a desired length of time, or an open travel option. The travel criteria may also include a desired travel location input specifying where the customer would like to travel, which could specify a desired geographic region, a desired climate, and/or a desired type of location. Other travel criteria may also include a desired travel type input specifying the type of travel the customer would like to experience, which includes but is not limited to any or all of the following: adventure, novelty, inconvenience, pampering, service quality, food quality, local content importance, eco-travel importance, excitement, human interaction importance, a type of interaction, shopping, entertainment, convenience, view from a hotel room, facilities including a beach, a pool, a restaurant, proximity to an entrance, security, child friendly elements, pet friendly elements, handicapped facilities, medical facilities, connecting rooms, private villa, specified number of beds, number of people that will travel, a level of language translation, and/or business services including secretarial, video conferencing, telephone service, internet connectivity, type of profile of other guests, age, sex, orientation, ethnic origin, religion, diet, sports related activities, club association, type of music enjoyed, type of movies, favorite celebrities, personality profile, dating profile, economic profit, geographic profile.

The customer may also be able to assign a ranking of importance to some or all of the criteria. In this case there is a ranking input associated with some or all of the criteria input controls, and the customer would select the ranking as he enters each criteria. The ranking may be simple (high or low) or may be more granular, for example on a sliding scale of 1 through 5. By providing the ranking of importance with each criteria, the travel discovery and reservation computer will be able to give greater weight to those lifestyle or travel criteria that have been assigned a high ranking, and also give a lesser weight to those criteria that have been assigned a lower ranking.

The travel discovery and reservation computer generates a set of travel predictors by analyzing one or more of the travel criteria provided by the customer. The predictors are general recommendations for a trip, and predict what the customer would like to do based on the criteria that has been input. The predictors may be general recommendations such as “a ski trip in South America next summer”, or “an educational cruise in Asia next spring”, or “a wine tasting tour of Northern California in the fall”, etc. Optionally, a previously stored preference file of the customer is additionally used by the travel discovery and reservation computer to generate the set of predictors along with the criteria entered by the customer. The preferences in the preference file may be obtained directly from the customer via the registration process, or via an analysis of criteria that have been previously entered and stored, or through external sources and databases. The preferences may indicate a preferred mode of travel (e.g railroad rather than flights). The preferences may be used to fill in the blanks for criteria that may not have been entered by the customer. Similarly, a group of previously stored preference files associated with a group of customers (such as the customer's family) are additionally used by the travel discovery and reservation computer to generate the set of predictors. If desired, the travel discovery and reservation computer may allow the criteria provided by the customer to override the previously stored preferences of the customer. Optionally, a previously stored travel history of the customer is additionally used by the travel discovery and reservation computer to generate the set of predictors.

The travel discovery and reservation computer then uses the predictors to generate a series of proposed travel segments for each travel category (transportation, lodging, meals and events), and the proposed travel segments are all combined into one or more proposed master travel itineraries. Each of the proposed master travel itineraries will have a segment option selection menu that includes various suggested options for the segments that have been proposed or suggested in each travel category. After segments are selected, additional options or further criteria modifiers are presented to the user so that a greater degree of selectivity may be acquired by the travel and reservation computers analytical systems. The travel discovery and reservation computer then transmits the proposed master travel itineraries to the customer, whereby the customer may select those segments which are of interest and delete or reject those which are of no interest.

The travel discovery and reservation computer then reconfigures and “reshuffles” the segment selection menu of the proposed master travel itineraries and presents them again to the customer. The process is continued and repeated until the customer is satisfied with one of the proposed master itineraries. The customer then executes a send key or button to confirm to the travel discovery and reservation computer that the customer is satisfied with the provisional itinerary result or has made an additional change or selection which begins the process again and continues until the customer is satisfied with the final result.

The travel discovery and reservation computer will then transmit to each of a group of travel service provider computers a request for a travel offer related to the segment options selected by the customer. For example, if the customer selected a flight segment to take him from his hometown to the destination, then the travel discovery and reservation computer will send a request to at least one airline to provide an offer for that flight. The travel discovery and reservation computer will then receive from each of the travel service provider computers a travel offer responsive to the request specifying a travel service, a load factor, and a retail price normally charged for the travel service. For the flight segment, the offer from the airline would include the travel service which is a flight number with departure and arrival times, a load factor that specifies how crowded the flight is (e.g. 0.4 or 40%), and the going rate or retail price that the airline would normally charge for that flight (e.g. $500).

The travel discovery and reservation computer will generate, for each travel offer received from the travel service provider computers, a discounted travel offer having a discounted price correlated to one or more parameters including but not limited to the associated load factor, the season or time of travel, the number of segments to be booked, the proximity of booking to expiration date and/or the desirability of the particular customer requesting the itinerary from the travel discovery and reservation computer. The travel discovery and reservation computer will then add the discounted travel offers to the proposed master travel itinerary, which may include an indication of the discounted travel offers having the lowest relative discounted price. The travel discovery and reservation computer then transmits the proposed master travel itinerary with the travel offers to the customer computer for review by the customer. If several offers are presented for a given travel segment, the customer may review the pricing and other details on those offers and make the desired selection(s). For example, three different flight offers may be provided as options to the customer, and he can choose which one he would like (which may be based on any factor such as price, carrier, time of travel, etc). Offers may be presented in a hierarchy of price, desirability, profit margin, service, profile or other criteria suitable to the desires of either the customer, the travel provider or third party service intermediary.

In an alternative embodiment, the travel discovery and reservation computer may opt to obtain the travel offers from the service providers prior to presenting the proposed master travel itinerary to the customer, in order to provide the customer with more details (such as pricing) help the customer make his initial segment selections. In this case, the travel discovery and reservation computer interacts with the travel service providers immediately after it has generated the travel predictors and generated the proposed master travel segments in order to obtain the travel offers, then generates the discounted travel offers and uses the discounted travel offers to compile the proposed master travel itinerary. The customer may then choose the desired segments and specific offers and delete the undesired ones, and the travel discovery and reservation computer then reconfigures and reshuffles the offer selection menu of the proposed master travel itinerary and presents it again to the customer. The process is continued and repeated until the customer is satisfied with the master itinerary result. The customer then executes a send key or button to confirm to the travel discovery and reservation computer that the customer is satisfied with the master itinerary result.

In either case, the travel discovery and reservation computer may generate the discounted travel offers having the discounted prices by using a static table-driven process by referencing a predetermined discount rate table for the associated travel service provider computer to retrieve a predetermined discount with that provider, and then applying the retrieved predetermined discount to the retail price to generate the discounted price. The predetermined discount obtained from the discount rate table may be applied as a function of one or more parameters in a discount algorithm, including but not limited to the load factor, the season or time of travel, the number of segments to be booked, the proximity of booking to expiration date and/or the desirability of the particular customer requesting the itinerary from the travel discovery and reservation computer.

In an alternative embodiment, the travel discovery and reservation computer generates the discounted travel offers having the discounted prices using a dynamic real-time interactive process by transmitting, to the travel service provider computer associated with the travel offer, a request for a real-time discount. The real-time discount obtained from the travel service provider may be calculated as a function of one or more parameters in a discount algorithm including the load factor, the season or time of travel, the number of segments to be booked, the proximity of booking to expiration date and/or the desirability of the particular customer requesting the itinerary from the travel discovery and reservation computer. The travel discovery and reservation computer then receives the real-time discount from the travel service provider computer, and it applies the received real-time discount to the retail price to generate the discounted price offer. In the alternative, a combination of the static table-driven process and the dynamic real-time interactive process may be implemented.

The travel discovery and reservation computer may assign a mathematical value to a customer or group of customers demonstrating that customer's or group of customers value to a particular service provider or category of service based upon the predicted value of that customer, category or group of customers. Values may be presented either as a single use or lifetime value of the customer, group of customers or category of customer to that service provider or category of service. The service provider may then correlate a discount taken from a table based algorithm or determine a discount established real time by factors other than those used in the rate table. The travel discovery and reservation computer may then forward those discounted rates to the customer or determine that the rates are not of sufficient suitability to be passed on to the customer.

Optionally, the discounts provided by a travel service provider may vary as a function of the amount of discounts that have already been provided over a certain time period. For example, a travel service provider may require that no further discounts are given if more than a maximum number of discounts have already been provided, and it may vary the rate of discount if half the maximum number has been reached, etc.

Optionally, the travel discovery and reservation computer may receive from the customer computer a request for an alternate master travel itinerary. In this case, the travel discovery and reservation computer will compile an alternate master travel itinerary that includes a different subset of the discounted travel offers, and then transmit the alternate master travel itinerary to the customer computer for review by the customer. If desired, the travel discovery and reservation computer may request alternate travel offers from the travel service provider computers for inclusion in the alternate master travel itinerary. After the travel discovery and reservation computer receives any alternate travel offers from the travel service provider computers, it will generate for each received alternate travel offer a discounted alternate travel offer having a discounted price as discussed above. The travel discovery and reservation computer will then use the discounted alternate travel offers for compiling the alternate master travel itinerary(s).

The travel discovery and reservation computer may also revise the proposed master travel itinerary(s) based on additional or revised criteria received from the customer computer. The criteria may be added or revised on the fly via a criteria modification box displayed on the web page. Similarly, the customer may select or enter keywords from a keyword selection menu box also provided on the web page, which is used by the travel discovery and reservation computer to further revise the proposed master travel itinerary(s). After each new criteria selection or input is provided by the customer, the travel discovery and reservation computer reorganizes and reshuffles the group of segment offers to include both new and updated opportunities based upon the improved or enlarged data set of criteria. In order to aid the customer in comparing various travel itineraries proposed by the travel discovery and reservation computer, one or more master travel itineraries may be stored in memory for subsequent retrieval and review by the customer.

Optionally, the customer may reject one or more of the segment option prices of the master itinerary proposed by the travel discovery and reservation computer. In this situation, the customer has an interest in the segment option presented but feels the price is too high. For example, the segment presented may be a museum tour with a price offered of $25 per person, and the customer may like the tour but only want to pay $15 per person. If this occurs, the travel discovery and reservation computer after receiving these segment option price rejections may generate a price counteroffer for the each of the rejected segment option prices, and then send the price counteroffers to each of the associated travel service provider computers. The travel service provider computers may then either accept or reject the price counteroffers generated by the travel discovery and reservation computer. The travel discovery and reservation computer may then include any accepted price counteroffers in a revised master itinerary that is transmitted to the customer computer. In another case, the customer provides to the travel discovery and reservation computer via the customer computer a price counteroffer for the each of the rejected segment option prices of the master travel itinerary, and the travel discovery and reservation computer will then send the customer's price counteroffers to each of the associated travel service provider computers. The travel service provider computers may then either accept or reject the customer's price counteroffers provided by the travel discovery and reservation computer. The travel discovery and reservation computer may then include any accepted customer price counteroffers in a revised master itinerary that is transmitted to the customer computer.

The customer may also reject a segment in its entirety if he does not like what is being offered by that segment. For example, if the segment offered is a museum tour, the customer may not want to go on the tour of the specified museum. If this occurs, the travel discovery and reservation computer after receiving these segment rejections may generate a segment alternative for the each of the rejected segments, and either present the segment alternative to the customer immediately, or first send the segment alternative to the appropriate travel service provider computer(s) and request an offer. The travel service provider computers may then provide an offer responsive to the request as set forth above. The travel discovery and reservation computer will then generate a discounted travel offer as also set forth above. The travel discovery and reservation computer will then add the discounted travel offers to the proposed master travel itinerary and transmits it to the customer computer for further review by the customer.

Once the customer wants to accept the proposed master itinerary, the customer computer will send the acceptance to the travel discovery and reservation computer. For each of the travel segment offers included in the accepted master travel itinerary, a reservation is made with the travel service provider computer that supplied the accepted offer. In the alternative to accepting the entire master itinerary, the customer may accept only selected segment options of the master travel itinerary. In this case, a reservation is made for each of the travel segment offers accepted by the customer with the associated travel service provider computer.

Once all of selected segment options of the master itinerary has been accepted by the customer, a proposed itinerary payment solution associated with the master travel itinerary is generated by the travel discovery and reservation computer. The proposed itinerary payment solution may include a monetary portion and a promotional portion, wherein the monetary portion is payable by the customer with legal tender and the promotional portion payable is by the customer with promotional currency. After being generated by the travel discovery and reservation computer, the proposed itinerary payment solution is sent to the customer computer for review by the customer. The monetary portion may if desired be a minimum monetary portion that specifies a minimum amount of legal tender required. The promotional currency may include reward points, a coupon, or a rebate. If the customer desires, he or she may modify the proposed itinerary payment solution by changing the proposed solution with controls provided by the travel discovery and reservation computer. As long as the proposed solution fits within any parameters that may be specified by the travel discovery and reservation computer (such as the minimum amount of legal tender that must be included in the payment), then the modified solution may be accepted. After the customer has either accepted the proposed itinerary payment solution or provided an acceptable modified itinerary payment solution, the travel discovery and reservation computer causes payment to be made for the travel segment options indicated in the master travel itinerary in accordance with the monetary portion and the promotional portion of the itinerary payment solution. Payment solutions may be provided or requested simultaneously with or at any time in the process beginning with the original presentation of the segment option to the customer as directed by the customer or where price is a primary factor.

In another aspect of the invention involving social travel components, the travel criteria entered by the customer, the preferences stored for the customer, and optionally any itinerary revision keywords selected by the customer are used to generate a travel profile that is compared to other stored travel profiles of other customers. The customers having similar travel profiles may be matched so that they are given similar travel itineraries having some matched segments so that these matched customers can meet each other during the matched segments. For example, the travel discovery and reservation computer may match two different customer by placing them on the same ski trip, and then providing a means for these customers to meet each other during the ski trip, such as by organizing a group meeting or the like.

In addition, the customer is able to re-enter the system after he has completed his trip, and provide feedback in the form of ratings for each segment of the trip and/or the service provider for that segment. When the rating system is used, it will also be made available to the customer during the itinerary reservation phase, wherein ratings of segments and the associated service providers are accessible to the customer, which may be limited to only those ratings from people in the customer's social network(s).

The system of the present invention that implements the above methods and processes includes a travel discovery and reservation computer interconnected to a network such as the Internet. In addition, the system includes a customer computer that is interconnected to the network for communications with the travel discovery and reservation computer. The travel discovery and reservation computer is also interconnected via one or more networks to a variety of travel service provider computers.

At least one of the travel service provider computers may be a transportation service provider computer, wherein the travel offer received from the transportation service provider computer specifies a transportation segment option that provides transportation that is responsive to the request by the travel discovery and reservation computer. For example, a transportation service provider computer may be an airline flight reservation computer, wherein the travel offer received from the airline flight reservation computer specifies a transportation segment option of an airline flight responsive to the request by the travel discovery and reservation computer. Or, the transportation service provider computer may be a railroad reservation computer, wherein the travel offer received from the railroad reservation computer specifies a transportation segment option of an railroad trip responsive to the request by the travel discovery and reservation computer. Or, the transportation service provider computer may be an automobile rental reservation computer, wherein the travel offer received from the automobile rental reservation computer specifies a transportation segment option of an automobile rental responsive to the request by the travel discovery and reservation computer.

At least one of the travel service provider computers may be a lodging service provider computer, wherein the travel offer received from the lodging service provider computer specifies a lodging segment option that provides lodging that is responsive to the request by the travel discovery and reservation computer. For example, the lodging service provider computer may be a hotel reservation computer, wherein the travel offer received from the hotel reservation computer specifies a lodging segment option of a hotel room reservation responsive to the request by the travel discovery and reservation computer.

At least one of the travel service provider computers may a meal service provider computer (such as a restaurant computer), and wherein the travel offer received from the meal service provider computer specifies a meal segment option that provides meals that is responsive to the request by the travel discovery and reservation computer. At least one of the travel service provider computers may be an event service provider computer, wherein the travel offer received from the event service provider computer specifies an event segment option of a reservation for an event responsive to the request by the travel discovery and reservation computer. For example, the event service provider computer may be a theme park reservation computer, wherein the travel offer received from the theme park reservation computer specifies an event segment option of a theme park admission responsive to the request by the travel discovery and reservation computer. Or, the event service provider computer may be a theater reservation computer, wherein the travel offer received from the theater reservation computer specifies an event segment option of a theater admission responsive to the request by the travel discovery and reservation computer. Or, the event service provider computer may be a sporting event service provider computer, wherein the travel offer received from the sporting event service provider computer specifies an event segment option of a sporting event admission responsive to the request by the travel discovery and reservation computer. Or, the event service provider computer may be a tour group reservation computer, wherein the travel offer received from the tour group reservation computer specifies an event segment option of a tour group admission responsive to the request by the travel discovery and reservation computer.

At least one of the travel service provider computers may be a third party aggregator reservation computer, wherein the travel offer received from the third party aggregator reservation computer specifies any of the following: a transportation reservation responsive to the request by the travel discovery and reservation computer, a lodging reservation responsive to the request by the travel discovery and reservation computer, a meals reservation responsive to the request by the travel discovery and reservation computer, or an event reservation for an event responsive to the request by the travel discovery and reservation computer.

### BRIEF DESCRIPTION OF THE DRAWING

FIG. 1 is an overall block diagram of the travel discovery and reservation system of the present invention.

FIG. 2 is a block diagram of the travel discovery and reservation computer of FIG. 1.

FIG. 3 is an illustration of the various types of travel service provider computers of FIG. 1.

FIG. 4 is a screen shot of a main web page for criteria entry.

FIG. 5a is a screen shot of a type criteria entry web page.

FIG. 5b is a screen shot of a facilities criteria entry web page.

FIG. 5c is a screen shot of a lodging criteria entry web page.

FIG. 5d is a screen shot of a food and entertainment criteria entry web page.

FIG. 6 is a screen shot of a date criteria entry web page.

FIG. 7 is a screen shot of a location criteria entry web page.

FIG. 8 is a screen shot of a budget criteria entry web page.

FIG. 9 is a detailed block diagram of the travel discovery and reservation system of FIG. 1.

FIG. 10 is a flowchart of the overall operation of the present invention.

FIG. 11 is a flowchart of the detailed operation of generating discounted travel offers by the travel discovery and reservation computer.

FIG. 12 is a screen shot of an itinerary presentation and revision web page.

FIG. 13 is a detailed illustration of a proposed master itinerary.

FIG. 14 is a detailed illustration of a proposed master itinerary with pricing displayed for each travel segment.

FIG. 15 is an additional detailed illustration of a proposed master itinerary.

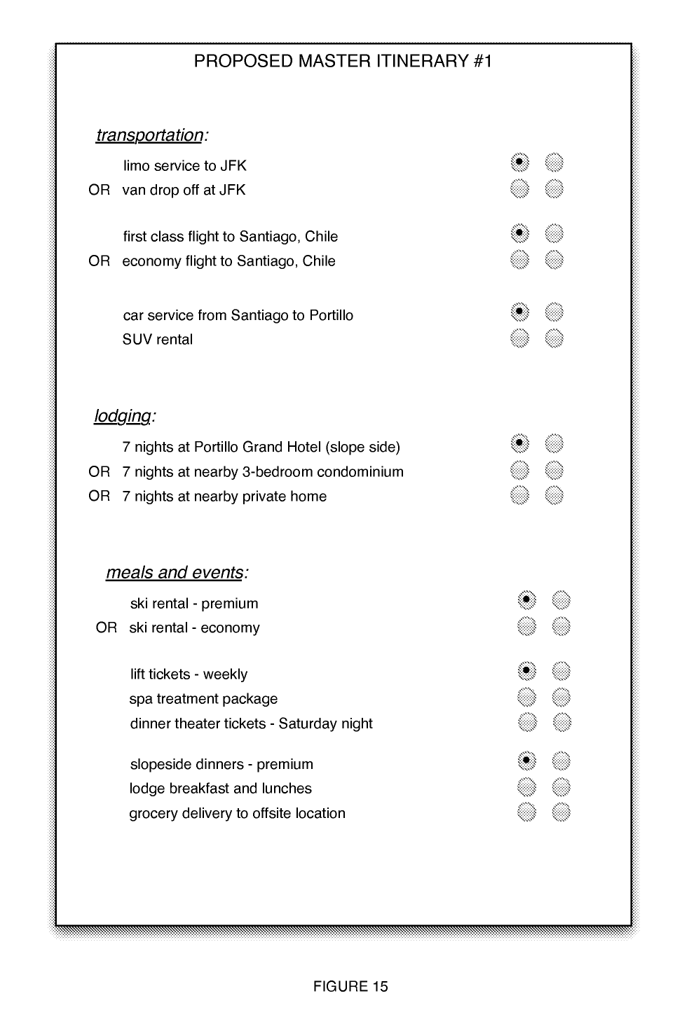

FIG. 16 shows an exemplary embodiment of the criteria modification box.

FIG. 17 shows an exemplary embodiment of the keyword entry box.

FIG. 18 is a flowchart of the payment process.

FIG. 19 is a screen shot of a payment solution display web page.

### DESCRIPTION OF THE PREFERRED EMBODIMENTS

### System Configuration

### Customer Computers

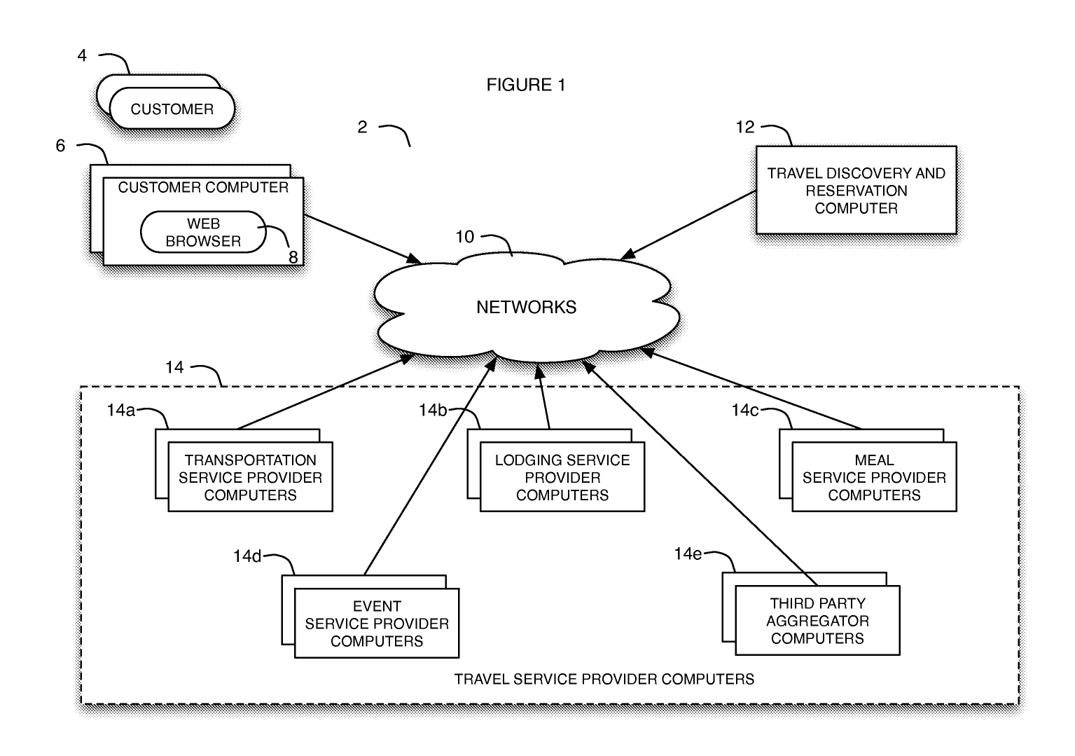

The present invention will now be described with respect to the preferred embodiments. FIG. 1 is an overall block diagram of the travel discovery and reservation system 2 of the present invention. A customer 4 interacts within the system 2 via a customer computer 6, which may be any type of computing device that enables the display, input and communications functionality of the invention described herein. A customer is typically the end-user who is using the system to plan and book a trip on his own behalf (individually or with others such as his family), but a customer may also include an intermediary user such as a travel agent who plans and books the trip on an end-user's behalf. In the preferred embodiment, the customer will interact within the system 2 via a web browser program 8 that communicates with web servers and other types of server-based software programs as well known in the art. Typically the customer computer 6 will be a personal computer such as a desktop computer or a portable computer (i.e. notebook) executing any type of operating system such as WINDOWS, MAC OS, CHROME, LINUX etc. that can run a web browser such as INTERNET EXPLORER, SAFARI, FIREFOX, GOOGLE CHROME, etc. In addition, a standalone client program that executes independent of a web browser may be used to interact within the system 2 if desired. The customer computer may also be a hand-held mobile device such as an IPHONE mobile phone, IPAD tablet, IPOD TOUCH, ANDROID device, WEB OS device, etc. Since these mobile devices can run browser applications, they easily interact within the system 2 in the same or substantially similar manner as their desktop counterparts. In addition, mobile applications (“apps”) may be used instead of a browser in order to interact within the system 2 in a manner well know in the art.

### Network

The system 2 as showing FIG. 1 includes a network 10 that enables communications amongst the various parties and components of the system 2. The network 10 typically is a wide area network such as the Internet, which enables global communications amongst the various parties and components as well known in the art. The network 10 may also include various other networking technologies as may be required by the embodiments of the various computers that interact with each other, such as local area networks and wireless networks in the case wherein the customer computer 6 is a wireless mobile device such as an IPHONE. Thus, the network 10 is intended to encompass any communications path or combinations of paths that are implemented for the various parties to exchange information in accordance with this invention.

### Travel Discovery and Reservation Computer

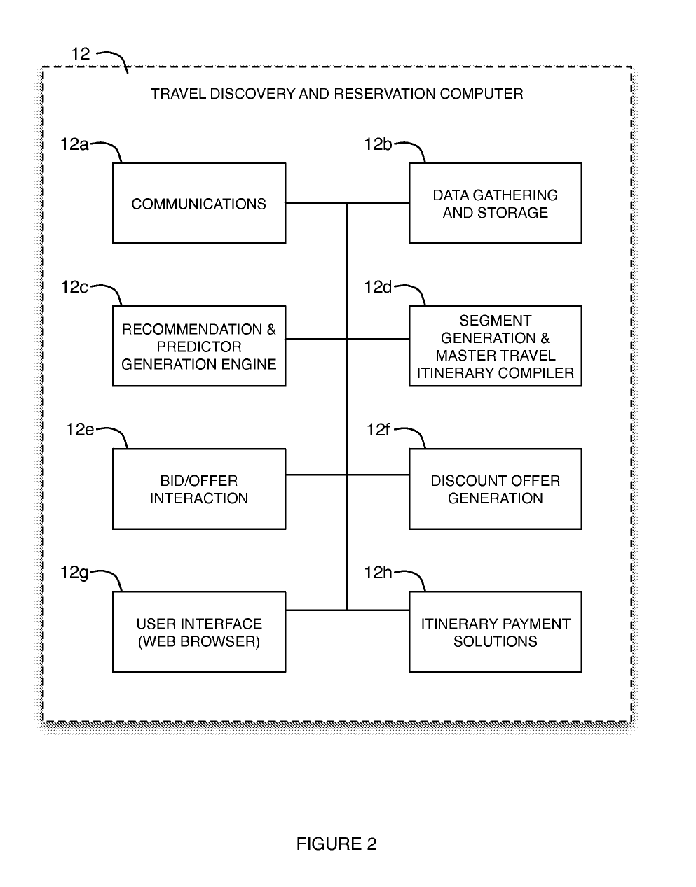

Also shown in FIG. 1 is a travel discovery and reservation computer 12, which is a central hub and provides the numerous functions of this invention as shown by the modules 12a-12h in FIG. 2. Communications module 12a provides for interacting with the customer computer 6 and various travel service provider computers 14 via the network 10. Data gathering and storage module 12b provides for collection of data from various external sources as well as internal databases, and storing the pertinent data for subsequent use. Recommendation and prediction generation engine module 12c provides for the generation of recommendations and predictors for customers based on various data as will be further described herein. Segment generation and master travel itinerary compiler 12d will generate suggested travel segments based on the predictors, and also compile and revise various proposed master travel itineraries that include those travel segments for the customer. Bid/offer interaction module 12e controls the process whereby the travel discovery and reservation computer 12 generates requests for bids and/or offers from the various travel service provider computers 14 as further described herein. Discount offer generation module 12f controls the process whereby the offers that are provided to the travel discovery and reservation computer 12 from the various travel service provider computers 14 are discounted prior to presentation to the customer. User interface module 12g controls the generation of web pages and/or other interface elements for interaction with the customer computer via the communications module 12a. Itinerary payment solution module 12h generates proposed payment solutions for the master itinerary and/or any segment thereof, and executes those payment solutions with various entities as will be described herein. All of the functionality of these main modules of the travel discovery and reservation computer as well as other functions will be described in this specification herein.

### Travel Service Providers

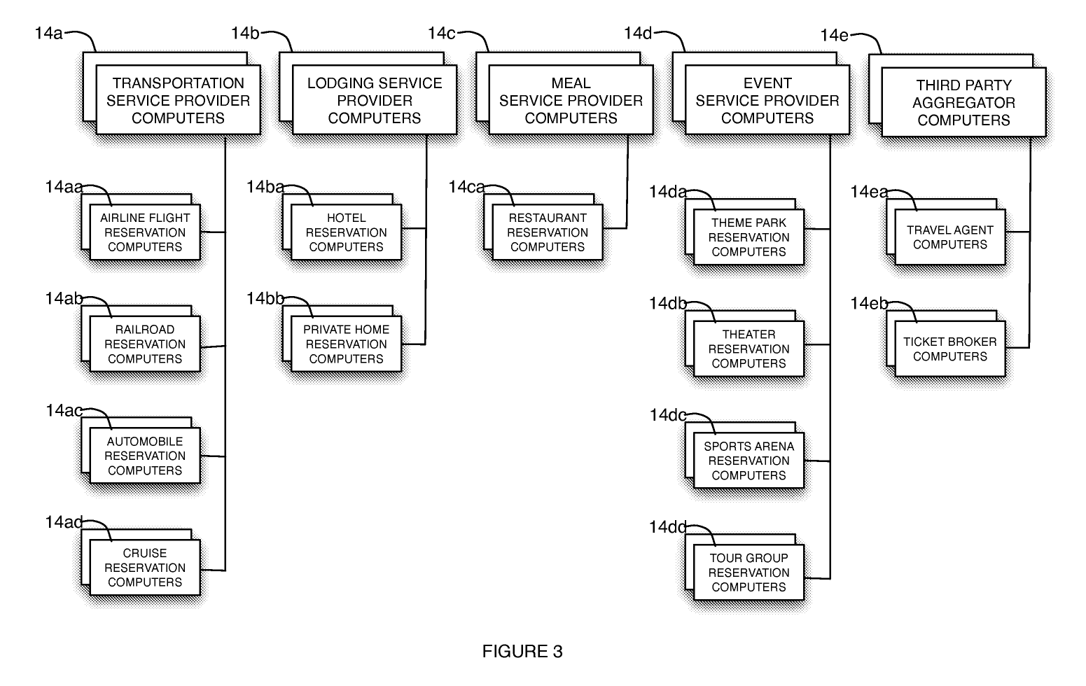

FIG. 1 also shows travel service provider computers 14, which include various types of computer systems that are controlled and operated by various travel service providers. Travel service provider computers include (but are not limited to), as shown, transportation service provider computers 14a, lodging service provider computers 14b, meal service provider computers 14c, event service provider computers 14d, and third party aggregator computers 14e. Transportation service provider computers 14a represent a class of travel service provider computers 14 that are operated by transportation providers, including but not limited to airlines, railroad, and automobile rental service providers. Thus, transportation service provider computers 14a may include (but are not limited to) airline flight reservation computers 14aa, railroad reservation computers 14ab, automobile rental reservation computers 14ac, and/or cruise reservation computers 14ad. These various transportation service provider computers are shown in FIG. 3. Airline flight reservation computers 14aa are operated by airlines such as DELTA, AMERICAN AIRLINES, SOUTHWEST, etc. These airline flight reservation computers 14aa interact with the travel discovery and reservation computer 12 to provide offers for airline flight travel segments as will be further described herein. Railroad reservation computers 14ab are operated by railroads such as AMTRAK, ACELA, TGB, etc. These railroad reservation computers 14ab interact with the travel discovery and reservation computer 12 to provide offers for railroad travel segments as will be further described herein. Automobile reservation computers 14ac are operated by automobile rental companies such as AVIS, HERTZ, and ENTERPRISE. These automobile reservation computers 14ac interact with the travel discovery and reservation computer 12 to provide offers for automobile rental travel segments as will be further described herein.

Similarly, lodging service provider computers 14b represent a class of travel service provider computers 14 that are operated by lodging providers, including but not limited to hotels (independent and chain, owned and managed), bread-and-breakfast lodges, and private home exchange, time share or rental services. Thus, lodging service provider computers 14b may include (but are not limited to) hotel reservation computers 14ba and/or private home exchange/rental reservation computers 14bb. These various lodging service provider computers are shown in FIG. 3. For example, hotel reservation computers 14ba are operated by hotel companies such as HILTON, MARRIOTT, and BEST WESTERN. These hotel reservation computers 14c interact with the travel discovery and reservation computer 12 to provide offers for hotel lodging travel segments as will be further described herein.

Likewise, meal service provider computers 14c represent a class of travel service provider computers 14 that are operated by meal providers, including but not limited to restaurants (independent and chain). Thus, meal service provider computers 14c may include (but are not limited to) restaurant reservation computers 14ca. These meal service provider computers are shown in FIG. 3. For example, restaurant reservation computers 14ca are operated by restaurant services such as OPEN TABLE. These restaurant reservation computers 14ca interact with the travel discovery and reservation computer 12 to provide offers for meal travel segments as will be further described herein.

In addition, event service provider computers 14d represent a class of travel service provider computers 14 that are operated by event and entertainment reservation providers, including but not limited to theme parks, theaters, sports arenas, and tour groups. Thus, event service provider computers 14d may include (but are not limited to) theme park reservation computers 14da, theater reservation computers 14db, sports arena reservation computers 14dc, and/or tour group reservation computers 14dd. These various event service provider computers are shown in FIG. 3. Theme park reservation computers 14aa are operated by them parks such as UNIVERSAL STUDIOS, DISNEY WORLD, BUSCH GARDENS, GREAT ADVENTURE, etc. These theme park reservation computers 14dd interact with the travel discovery and reservation computer 12 to provide offers for theme park travel segments as will be further described herein. Theater reservation computers 14db are operated by theaters such as broadway theaters, movie theaters, etc. These theater reservation computers 14db interact with the travel discovery and reservation computer 12 to provide offers for theater travel segments as will be further described herein. Sports arena reservation computers 14dc are operated by sports arenas such as MADISON SQUARE GARDEN, YANKEE STADIUM, etc. These sports arena reservation computers 14dc interact with the travel discovery and reservation computer 12 to provide offers for automobile rental travel segments as will be further described herein. Tour group reservation computers 14dd are operated by tour groups such as Grand Canyon helicopter flights, Alaska wilderness adventures, European museum tours, etc. These tour group reservation computers 14dd interact with the travel discovery and reservation computer 12 to provide offers for automobile rental travel segments as will be further described herein.

Third party aggregator computers 14e represent a class of travel service provider computers 14 that are operated by third party aggregators, including but not limited to travel agents and ticket brokers. Thus, third party aggregator computers 14e may include (but are not limited to) travel agent computers 14ea and ticket broker computers 14eb. These third party aggregator computers are shown in FIG. 3. For example, travel agent computers 14ea are operated by travel agents such as EXPEDIA and TRAVELOCITY. These travel agent computers 14ea interact with the travel discovery and reservation computer 12 to provide offers for various of the above-described travel services (transportation, lodging, etc.) as will be further described herein. Ticket broker computers 14eb are operated by ticket brokers such as travel agents such as STUB HUB, TICKETMASTER, etc. These ticket broker computers 14eb interact with the travel discovery and reservation computer 12 to provide offers for various of the event tickets as will be further described herein.

There are instances wherein certain of the travel service providers will provide services in more than one area. For example, a hotel may also provide meal reservations at an on-site hotel, and it may provide concierge services so that event tickets are also obtainable. Another example would be a cruise, which offers transportation services, lodging services, meal services, and event services (e.g. excursions). These types of services and service providers are contemplated by the present invention as ell as the single service providers mentioned above.

### System Operation

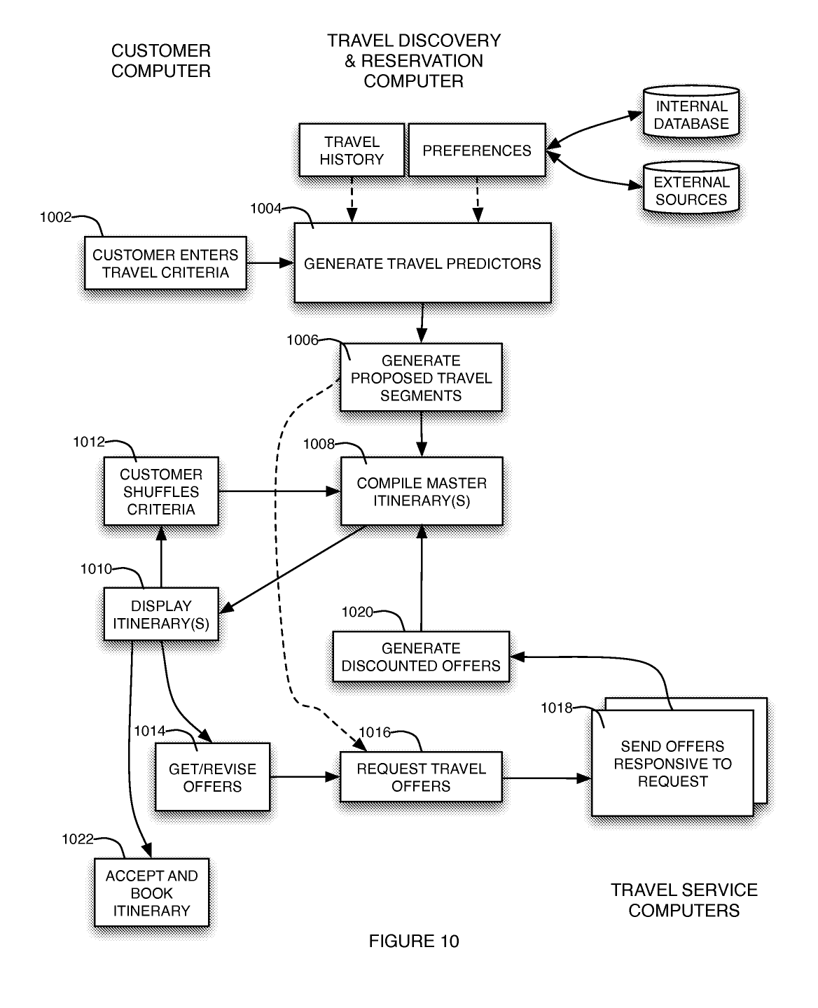

The system operation will be described with reference to the main flowchart of FIG. 10. The customer enters travel criteria at step 1002, which is used to generate travel predictors at step 1004. Alternatively, the step of travel predictor generation may include preferences of the customer or a related group (which may be obtained via internal databases or external sources), and/or the travel history of the customer or a related group. At step 1006, a set of proposed travel segments are generated, and at step 1008 one or more proposed master itineraries are compiled from the proposed travel segments. The master itineraries are then sent to the customer computer and displayed for review by the customer at step 1010. At step 1012 the customer may revise (shuffle) or add to the travel criteria and/or select keywords that have been presented at the customer computer display, and as a result the proposed master travel itineraries are revised per the new criteria and keywords. These steps 1008-1010-1012 may be iterated as desired by the customer until he provisionally accepts the proposed master travel itinerary currently displayed, at which point he will select a button on the display that will execute step 1014 in which he requests specific travel offers to be retrieved for the selected segments of the itinerary. At step 1016 the travel discovery and reservation computer 12 will request the pertinent travel offers from a group of travel service provider computers. At step 1018 the travel service provider computers send offers that meet the requests made by the travel discovery and reservation computer 12, and at step 1020 the travel discovery and reservation computer 12 generates a set of discounted offers. The discounted offers are then added to the master itineraries, sent to the customer for review and revision, etc. At some point the customer will be satisfied with the master itinerary and accept and book it at step 1022. These steps are now described in further detail below.

### Travel Criteria Entry

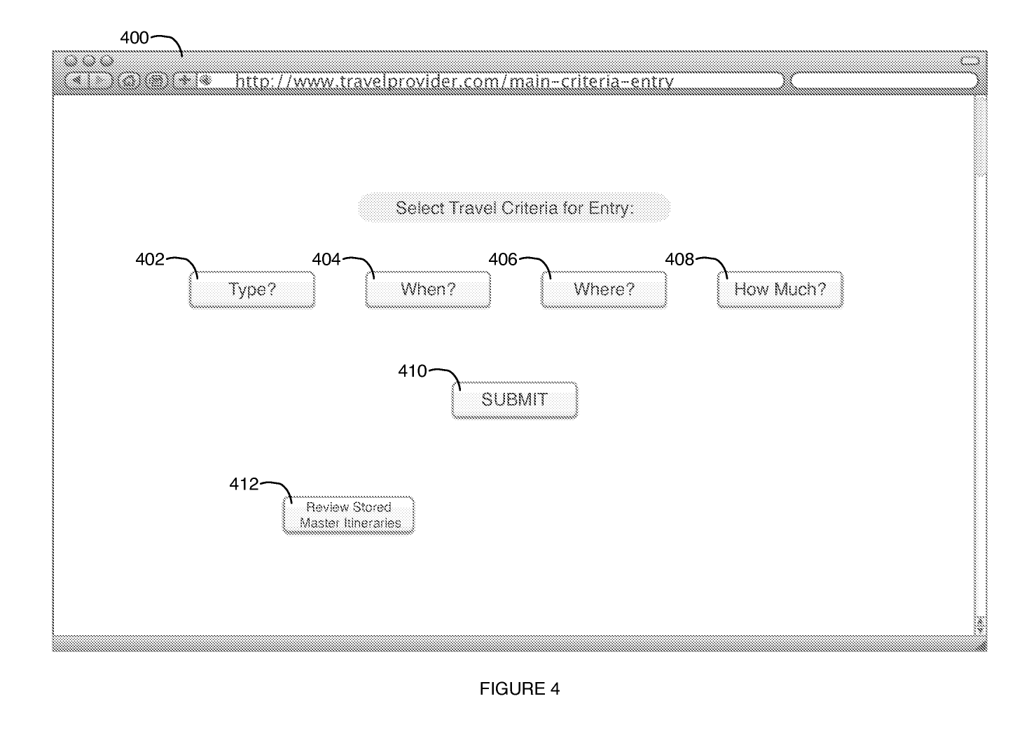

With respect to step 1002 of FIG. 10, FIGS. 4-8 illustrate screen shots of web pages that provide the user interface that enables a customer to enter various criteria, such as travel criteria, that are used by the travel discovery and reservation computer 12 to execute the functions of this invention. These web pages are generated and served by a web server executing on the travel discovery and reservation computer so that a web browser 8 running on the customer computer 6 can enable the customer to enter the desired criteria.

When the customer first loads the main or home page of the travel discovery and reservation computer web server (referred to herein as the travel discovery and reservation computer), and is able to register with the travel discovery and reservation computer by entering certain information such as a user name and password as well known in the art. Once the customer has registered with the travel discovery and reservation computer, he or she will enter his user name and password on subsequent visits. Optionally, the customer may be able to skip the initial registration process and utilize the functionality of the travel discovery and reservation computer as an anonymous user. In the event that the customer accepts a master itinerary proposed by the travel discovery and reservation computer as described below, then he would need to register in order to make payment and provide traveler information to complete the reservations. In addition, if the customer uses the system prior to registration, then the travel discovery and reservation computer will be unable to use that customer's preferences in compiling a master itinerary. Thus, registration and logging in to the travel discovery and reservation computer provides advantages over an anonymous user.

After the customer has registered and logged in, then the main criteria entry web page 400 is served by the travel discovery and reservation computer as shown in FIG. 4. Several buttons are provided to the customer to enable him to enter his desired travel criteria, which in this embodiment are grouped into four main sections.

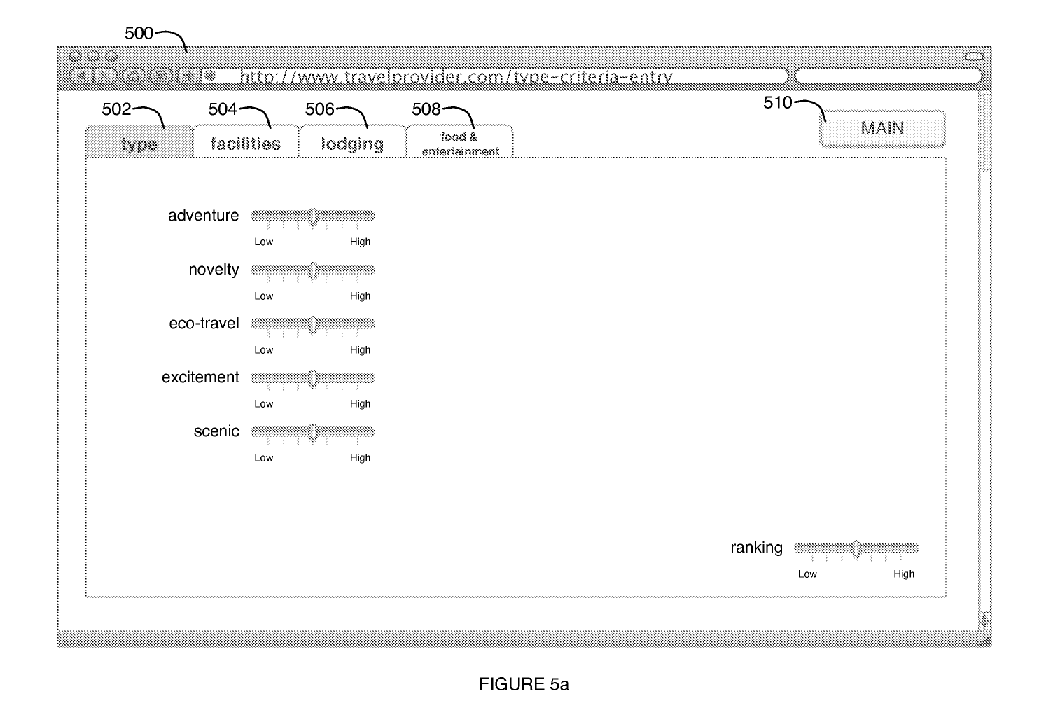

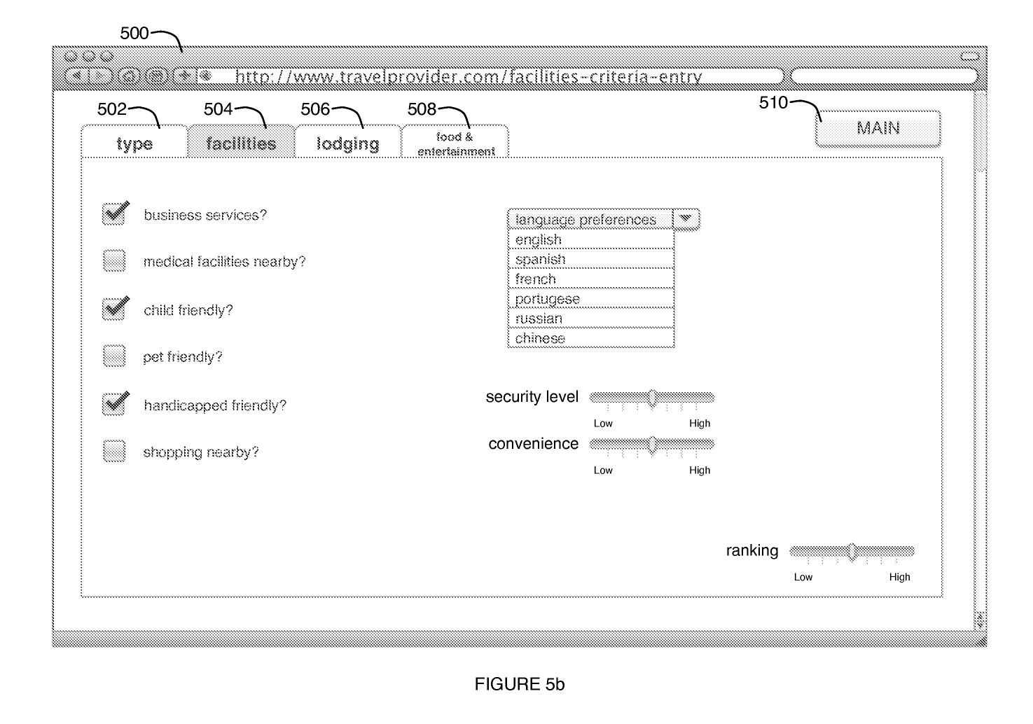

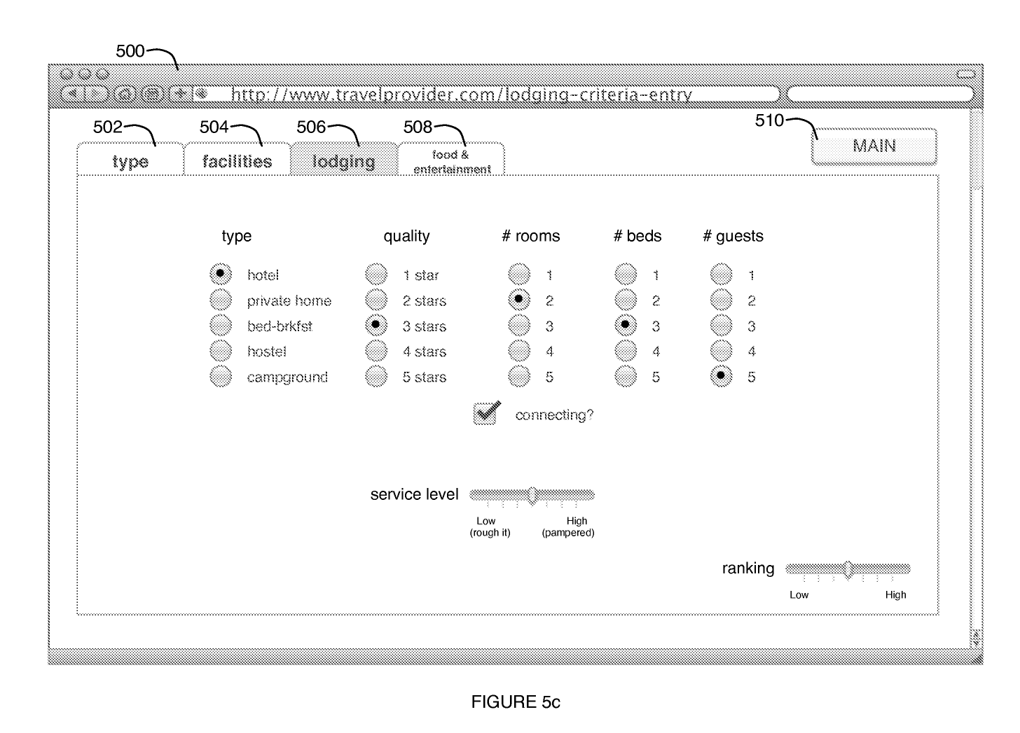

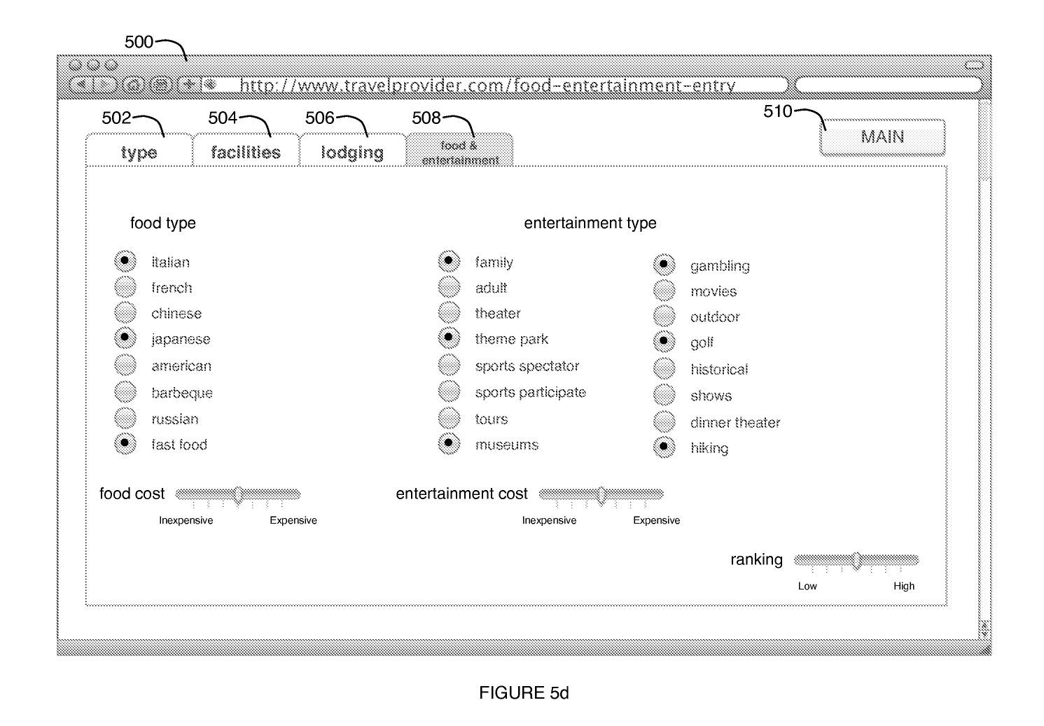

The first main section enables the customer to enter his criteria for the type of travel he is interested in. Selection of type button 402 will cause the type criteria entry main page 500 to be served by the travel discovery and reservation computer, as shown in FIG. 5a. Here the customer will view four tabs, which provide access to four type subsections (type, facilities, lodging and food & entertainment). By default, the first tabbed subsection will appear, as indicated by the type tab button 502. Several slider controls with descriptive labels are provided, which enable the customer to control the labeled inputs. Thus, by sliding the adventure slider control, the customer can indicate if he wants the relative level of adventure he would like in his trip. For example, a high adventure input might result in a mountain climbing expedition, while a low adventure input might result in a museum tour. As known in the art, slider controls are interface controls that allow for selection along a continuous range of input values from a low preset to a high preset. Other interface controls may be used with the scope of this invention, and the invention is not limited to the specific types of interface controls that are illustrated herein. As noted below, other types of interface controls for entering desired inputs are also implemented such as check boxes and radio buttons for indicating a yes/no or true/false condition, text inputs, drop down lists, calendar inputs, etc.

Other slider inputs available for selection by the customer are the novelty slider control, the eco-travel slider control, the excitement slider control, and the scenic slider control. With respect to the novelty slider control, a high degree of novelty might indicate that the customer would desire a type of trip that is unusual or novel, such as a rain forest tour in Brazil, while a low degree of novelty might indicate that the customer would like a more common type trip such as a visit to Disney World. The same analysis is undertaken with respect to the eco-travel, excitement, and scenic slider controls. Other types of inputs similar to these may also be used within the spirit and scope of the invention.

The customer may also be able to assign a ranking of importance to some or all of the criteria that he has specified. In this case there is a ranking slider control as shown in FIG. 5a (and FIGS. 5b, 5c, 5d, 6, 7 and 8) that provides a ranking input that is associated with the criteria input controls on the same page. In this embodiment, the customer can use the ranking slider control to specify that the criteria selectable on this page has a low importance ranking, a high importance ranking, or any value in between. By providing the ranking of importance for this subset of criteria, the travel discovery and reservation computer will be able to give greater weight to those travel criteria that have been assigned a high ranking, and also give a lesser weight to those criteria that have been assigned a lower ranking. In an the alternative to using one slider to control the relative importance of all the criteria on this page, individual sliders may be used alongside each of the criteria of the page (i.e. one next to each of adventure, novelty, eco-travel, excitement, and scenic). While this would provide more granularity and control of the importance ranking to the customer, it does require more thought on the part of the customer and takes longer. In addition, rather than a slider control, a series of radio buttons or other web controls may be used if desired.

The second tabbed subsection is displayed by selecting the facilities tab button 504, which will result in the display of the web page of FIG. 5b. In this section, the customer can indicate the type of general facilities that he would like to have on his trip. That is, these criteria apply to the overall itinerary of the trip and not just to the lodging section which will be discussed below. As seen in FIG. 5b, several check boxes are presented to indicate a yes/no answer to the following input criteria: business services availability (e.g. copiers, fax machines, Internet access etc.), nearby medial facilities, a child friendly environment, a pet friendly environment, a handicapped friendly environment, and/or nearby shopping availability. Also shown is a drop down list for language preferences, in which the customer may indicate any desired language capabilities of the facilities that will be included in the itinerary. For example if the customer is traveling with someone who speaks only French, he may want to select this language to designate this as a desired criteria. Also shown in FIG. 5b are two slider controls; the first to indicate a level of security and the second to indicate a level of convenience. Other types of inputs similar to these may also be used within the spirit and scope of the invention.

The third tabbed subsection is displayed by selecting the lodging tab button 506, which will result in the display of the web page of FIG. 5c. In this section, the customer can indicate the type of lodging that he would like to have on his trip. As seen in FIG. 5c, several single-selection radio button groups are presented to indicate a selection from the choices in the group. Here the customer may select the type of lodging from (for example) a hotel, a private home or villa, a bed and breakfast inn, a hostel, or a campground. The customer may also select the desired quality of the lodging, as indicated by the 1 through 5 star rating system universally known. The customer may also select the number of rooms that he would like, the number of beds, as well as the number of guests that will be traveling on this itinerary. He can also indicate if he would like connecting rooms by checking the appropriate check box, and a desired service level ranging from roughing it through pampered may be selected. Other types of inputs similar to these may also be used within the spirit and scope of the invention.

The fourth tabbed subsection is displayed by selecting the food & entertainment tab button 508, which will result in the display of the web page of FIG. 5d. In this section, the customer can indicate the type of food & entertainment that he would like to have on his trip. As seen in FIG. 5d, several multiple-selection radio button groups are presented to indicate selections from the choices in the group. Here the customer may select the type of food and the type of entertainment he would like to have on the trip. He also is presented with a food cost slider which allows him to designate a level of cost he is willing to pay for the food, from inexpensive to expensive. Similarly, he is presented with an entertainment cost slider which allows him to designate a level of cost he is willing to pay for the entertainment, from inexpensive to expensive. Other types of inputs similar to these may also be used within the spirit and scope of the invention.

The customer may select the tabs 502, 504, 506 and 508 in any desired order to enter the associated criteria, and he may retreat to any subsections and change his criteria as desired. After he has entered the criteria of these four subsections, he may select the main button 510 from any subsection and be returned to the main criteria entry web page 400 of FIG. 4.

A fifth section (not shown) may be provided for entering confidential information that would give the customer more control over sharing of this information (which may include sexual preferences, medical information, and the like). For example, the customer may wish to enter a sexual preference that may provide destinations that are friendly and cater to that preference, or he may indicate certain physical handicaps that are best served by certain types of lodging, etc.

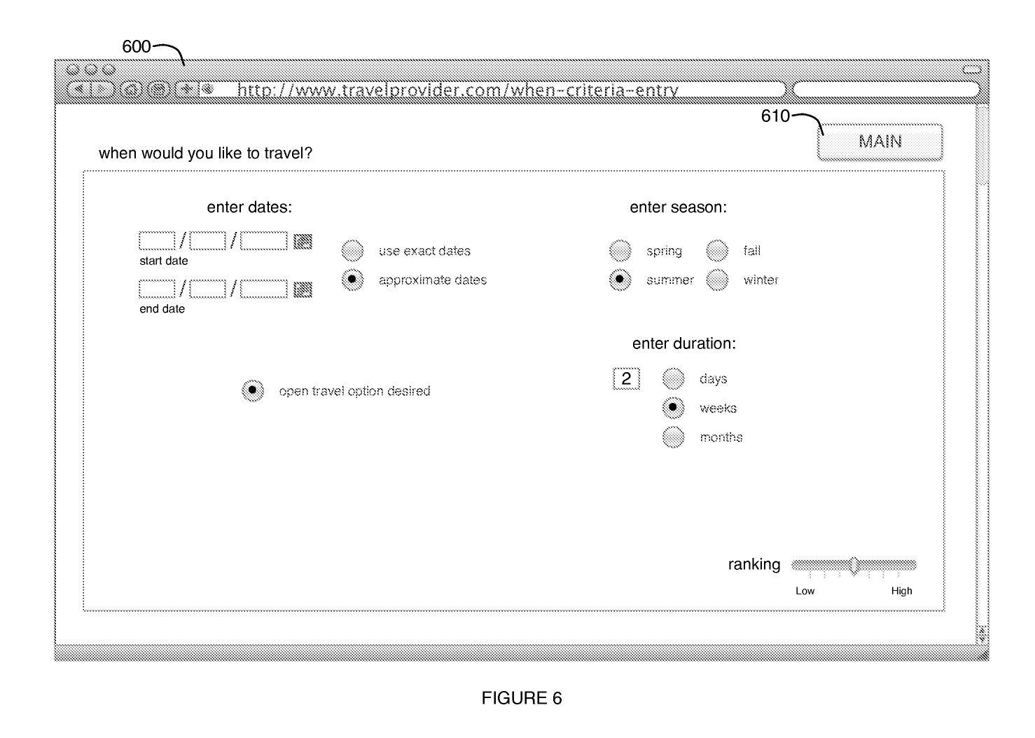

There, he may proceed to the next main section by selecting the when button 404, which will cause the time criteria entry web page 600 as shown in FIG. 6. On this page 600, the customer may enter the exact dates within which he would like to travel, or he may indicate that the time window entered is approximate. He may opt to enter a more general timeframe for travel, such as by selecting only a season of travel, or even a selection for an open travel window in which the dates are left open. He may also indicate a desired length of travel, such as in days, weeks or months. Other types of inputs similar to these may also be used within the spirit and scope of the invention. After he has entered the travel timeframe criteria of this section, he may select the main button 610 and be returned to the main criteria entry web page 400 of FIG. 4.

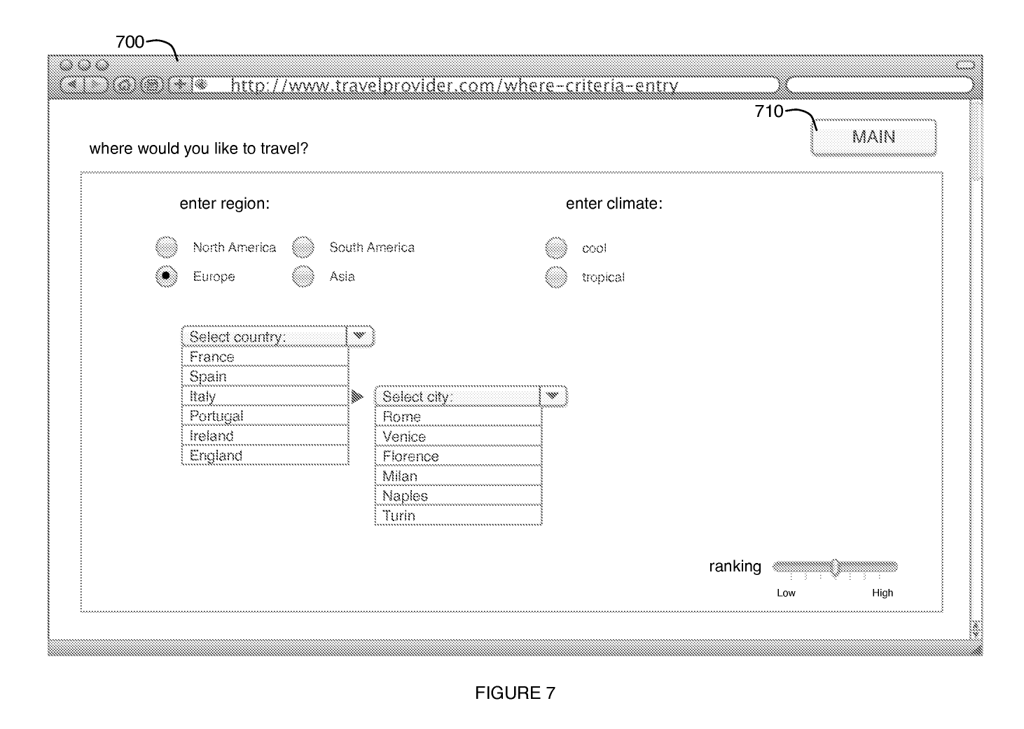

The next main section for criteria entry is retrieved by selecting the where button 406 from the main criteria entry web page 400 of FIG. 4. This will cause the where criteria entry web page 700 to be displayed as shown in FIG. 7. On this page 700, the customer may be general and select for example only a region such as North America, South America, Europe, or Asia by selecting from the radio button group as shown. He can also select a country (or countries) of a region as well as a city (or cities) in that country. For example, by selecting Europe, the customer is given a drop down list of several European countries. By selecting Italy, he is given a drop down list of several Italian cities, etc. Thus, the customer may be as general or specific as he would like in selecting where he would like to travel. In addition, he could specify a climate condition shown (for example cool or tropical). Other types of inputs similar to these may also be used within the spirit and scope of the invention. After he has entered the travel timeframe criteria of this section, he may select the main button 710 and be returned to the main criteria entry web page 400 of FIG. 4.

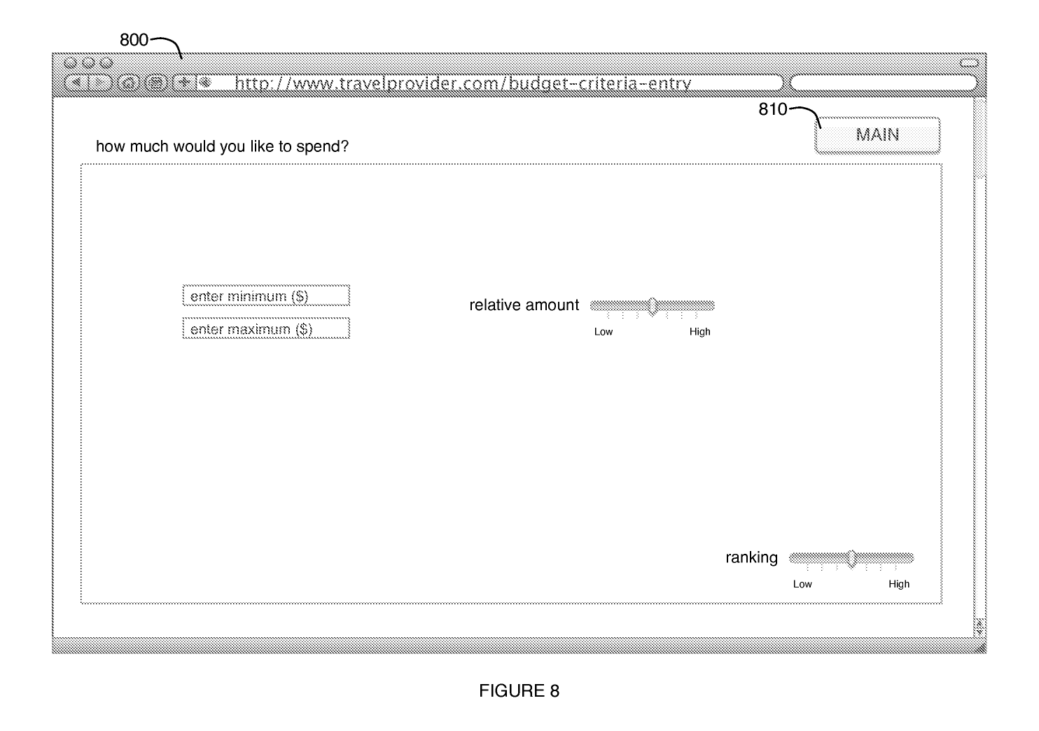

The next main section for criteria entry is retrieved by selecting the how much button 408 from the main criteria entry web page 400 of FIG. 4. This will cause the budget criteria entry web page 800 to be displayed as shown in FIG. 8. There he may enter a budget for travel in terms of a range of money that the customer is willing to pay for the trip (minimum and maximum amounts). He may also if desired use the relative amount slider control, which will indicate that he wants to spend a low amount or a high amount, relative to the various budgeted itineraries that may be available. This is helpful if the customer does not know how much a trip will cost but does know he want to spend as little as possible for the selected itinerary. Other types of inputs similar to these may also be used within the spirit and scope of the invention. After he has entered the travel budget criteria of this section, he may select the main button 810 and be returned to the main criteria entry web page 400 of FIG. 4.

### Customer Preferences and Travel History

In one embodiment, previously stored preferences of the customer are additionally used by the travel discovery and reservation computer to generate the set of predictors along with the criteria entered by the customer as described above. Preferences are used globally by the travel discovery and reservation computer to supplement the travel criteria entered by the customer for any particular itinerary request. Preferences act as a default criteria in the case where a customer does not enter certain criteria. For example, the preference file of a customer may indicate that he always desires to use a 4-star hotel in his trips. Optionally, this criteria may be used to pre-populate the lodging type and quality criteria inputs as shown in FIG. 5c. If the customer is provided with certain of the inputs pre-populated with his preferences, then he can leave those inputs as is or he can modify or override them as he desires. So, if the lodging criteria is pre-populated with a 4-star hotel criteria, he may change that to a 5-star hotel, a 3-star hotel, a private home, etc.

The preferences in the preference file may be obtained directly from the customer via the registration process, or via an analysis of criteria that have been previously entered and stored, or through external sources and databases. The customer may be asked to enter some or all basic criteria during registration, such as by answering questions such as “What type of lodging do you usually prefer?”. The customer may elect to provide that information, in which case it is stored in his preference file in the travel discovery and reservation computer. Alternatively, for example, if the customer does not provide his preferences during registration, the travel discovery and reservation computer may use travel criteria entered during one or more subsequent itinerary request sessions to fill in the blanks. So, for example, if the user continuously uses 4-star hotels, then that information is stored in his preference file for subsequent use in pre-populating the criteria entry web pages and forms. External sources and databases may also be used to determine preferences of a customer for certain travel segments. For example, the travel discovery and reservation computer may interact with third party data providers or aggregators, or with travel service providers directly, to determine certain preferences. For example, the travel discovery and reservation computer may determine from communicating with various hotel reservation computers that a certain customer always stays at 4-star hotels. This information may also be stored in his preference file for subsequent use in pre-populating the criteria entry web pages and forms.

In one embodiment, a group of previously stored preference files associated with a group of customers such as a family are additionally used by the travel discovery and reservation computer to generate the set of predictors. For example, a husband and wife may each have preference files stored by the travel discovery and reservation computer. When the husband logs in and enters his travel criteria, the travel discovery and reservation computer may have his preference file linked to his wife's preference file, so that her preferences are considered by the travel discovery and reservation computer in generating the predictors in addition to the husband's preferences.

Optionally, a previously stored travel history of the customer is additionally used by the travel discovery and reservation computer to generate the set of predictors. The previous history may be used to supplement, modify or replace various criteria input by the customer in a similar manner as the preferences described above.

### Predictor Generation

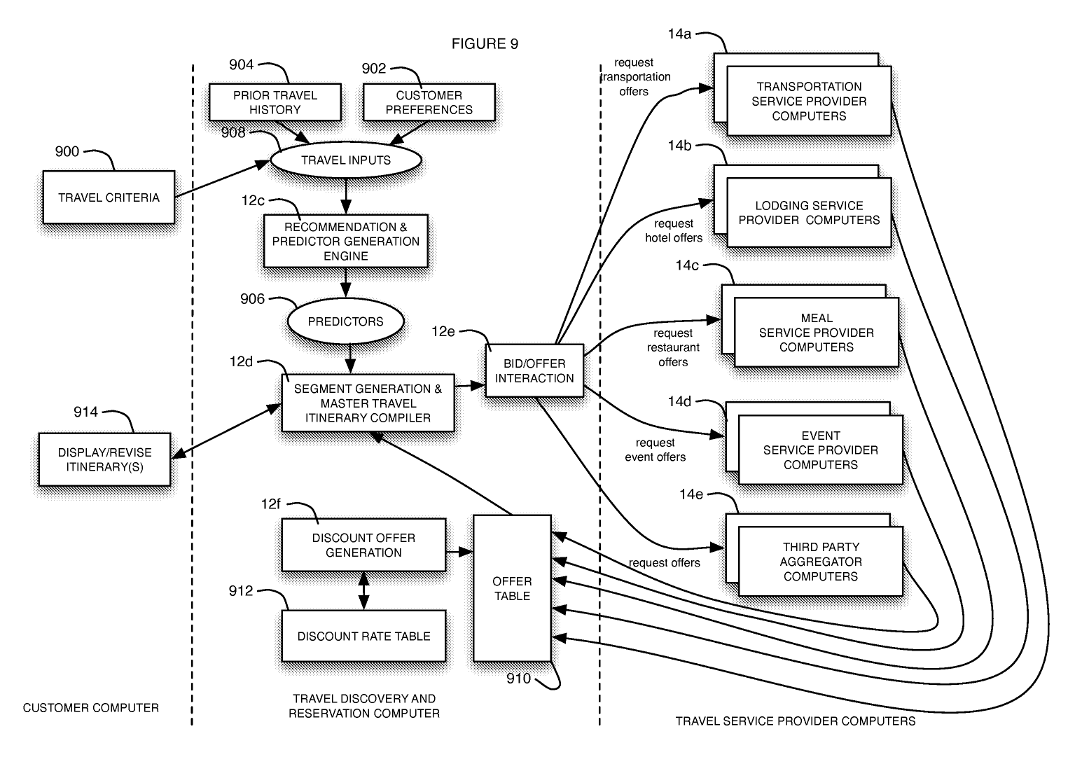

With reference to step 1004 of FIG. 10, and as shown in the block diagram of FIG. 9, one of the primary functions of the travel discovery and reservation computer 12 is to generate, via the recommendation and predictor generation engine 12c, a set of recommendations and travel predictors 906 based on travel predictor inputs 908 that include the travel criteria 900 input by the customer (weighted by any ranking that may have been assigned by the customer as described above), the preferences 902 of the customer and/or other customers in a predefined group, and the prior travel history 904 of the customer, all of which are previously described. The predictors 906 are used, at step 1006 of FIG. 10, by the segment generation and master travel itinerary compiler 12d of the travel discovery and reservation computer 12 to generate proposed travel segments and then compile those segments into a proposed master travel itinerary(s) at step 1008 for presentation to the customer via the customer computer. The bid/offer interaction module 12e utilizes the travel segments from the proposed master travel itinerary(s) to communicate with various travel service provider computers 14a, 14b, 14c, 14d, 14e and request travel offers related to the travel segments of the proposed master travel itinerary(s). The discount offer generation module 12f applies a discount to the received travel offers, and the discounted offers are added to the proposed master travel itinerary(s) for presentation to the customer.

First, the recommendation and predictor generation engine 12c implements intelligence in order to ascertain a predicted destination for the customer. By reviewing the various travel inputs 908, the recommendation engine 12c will determine where the customer may want to travel. For example, if the travel inputs 908 indicate a desired summer destination in which the customer can have sports participation with a relatively high degree of adventure and excitement and outdoor entertainment, and the preferences indicate that this user likes to ski, and the travel history indicates that this user has only skied in the winter months, then the predicted destination may be Chile in South America, where the customer can have a ski vacation during August. This would be a good match to the travel inputs 908. The recommendation engine may also be more granular and predict that the customer may want to stay at the Portillo Ski Resort in Chile for 10 days and have inexpensive dinners and one spa session during the week.

The travel discovery and reservation computer will then use this set of predictors 906 to generate proposed travel segments at step 1006 that are compiled into one or more proposed master itineraries at step 1008 for presentation to the customer via the customer computer at step 1010.

In an alternative embodiment, a random generator may be implemented that operates on the various travel predictor inputs 908 to generate the predictors 906, which are then used to generate proposed travel segments at step 1006 that are compiled into one or more proposed master itineraries at step 1008 for presentation to the customer.

### Travel Segment Generation

At step 1006 of FIG. 10, the travel discovery and reservation computer uses the predictors 906 to generate a series of proposed travel segments for each travel category (transportation, lodging, meals and events), and the proposed travel segments are all combined at step 1008 into one or more proposed master travel itineraries. Each of the proposed master travel itineraries have a segment selection menu that includes various suggested options for the segments that have been proposed or suggested in each travel category.

The segment generator component of the segment generation and master travel itinerary compiler 12d will analyze the set of predictors 906 and parse out what may be required or desired for the recommend trip, and place them in a database table as shown below. Once the destination has been parsed out, the segment generator can determine what type of transportation would be needed to take the customer from his home (which is known from his registration or preference information) to the destination. For example, if the recommended trip is to Portillo, Chile, and the customer lives in Greenwich, Conn., then the segment generator will generate the round trip transportation segments shown in the table below to provide the required transportation segments to and from the destination, which are assigned segment IDs 001, 002, 003, 004, 005, and 006.

SEGMENT TABLE

| ID | SEGMENT TYPE | DESCRIPTION |
|---|---|---|
| 001 | TRANSPORTATION | R/T limo service from Greenwich, CT |
| | | to JFK airport |
| 002 | TRANSPORTATION | R/T van service to JFK |
| 003 | TRANSPORTATION | R/T first class from JFK to |
| | | Santiago, Chile (SCL) |
| 004 | TRANSPORTATION | R/T economy flight from JFK to |
| | | Santiago, Chile (SCL) |
| 005 | TRANSPORTATION | R/T ground transport from SCL to |
| | | Portillo resort |
| 006 | TRANSPORTATION | Auto rental—10 days |
| 007 | LODGING | Slopeside lodging |
| 008 | LODGING | 3-bedroom condo |
| 009 | LODGING | Private home |
| 010 | EVENT | Premium ski rentals |
| 011 | EVENT | Economy ski rental |
| 012 | EVENT | Weekly lift tickets |
| 013 | EVENT | Spa package |
| 014 | EVENT | Dinner theater package |
| 015 | MEAL | Premium slopeside dinners |
| 016 | MEAL | Breakfast and lunch in ski lodge |
| 017 | MEAL | Grocery delivery to office location |

Thus, the segment generator has determined that ground transportation is needed to get the customer from his house to JFK airport and back, and has generated segments 001 and 002 for that segment of travel, from which the customer will select the desired segment. The segment generator has also determined that the customer will need a flight from New York to Santiago, Chile and back, and therefore has generated segments 002 and 003 for flights between JFK and SCL, from which the customer will select the desired segment. The segment generator has also determined that the customer will need ground transportation from SCL to the Portillo ski area and back, and therefore has generated segment 005 for this segment. Optionally, the customer may want to have the use of an automobile rental for the duration of the trip, and so the segment generator has provided segment 006 for this service. This is optional since the customer may decide to stay at a slopeside resort and really need a rental car to get around. The customer would then reject this segment when presented to him in the proposed master travel itinerary. If, however, the customer elects to take the rental car in segment 006, he may decide to rent the car or SUV at the SCL airport for the duration of the trip, and drive himself to the Portillo ski area. In this case, he may elect to reject segment 005 since he would use the rental car instead. Thus, as will be seen, the segment selection process is a dynamic process in which certain segments may be unnecessary based on selection of other segments.

Many other segments may be generated based on the complexity of the proposed trip. In addition, the customer may be presented with more segment choices for each required part of the trip, or he could be presented with only a single recommended option for that part. The granularity and detail of the segments that are generated may be tailored to each individual based on the criteria that has been entered as well as their preferences.

Segments may be generated for more than one potential itinerary that would be provided to the customer for review and selection as described below.

### Master Travel Itinerary Compilation

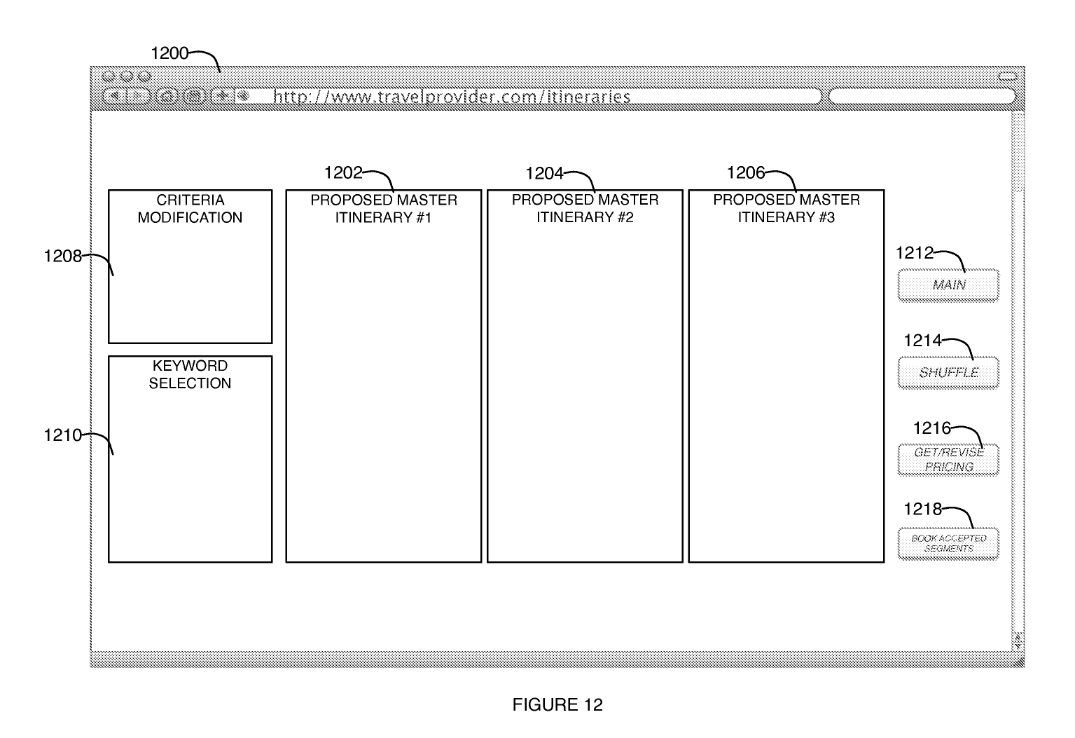

Once the various proposed travel segments have been generated at step 1006, the travel discovery and reservation computer 12 will compile on or more proposed master travel itineraries at step 1008. Compiling the proposed master itineraries will include generating one or more web pages that may be sent to the customer computer for display, review and revision by the customer. FIG. 12 shows a screen shot of an itinerary web page 1200 that provides the customer with the ability to view, modify, reject and accept one or more proposed master travel itineraries and their constituent segments that have been compiled by the master travel itinerary compiler 12f of the travel discovery and reservation computer 12. This itinerary web page 1200 is been transmitted to the customer computer 6 for display to and review by the customer 4 via step 1010 in FIG. 10. The exemplary itinerary web page 1200 provides three different proposed master itineraries 1202, 1204 and 1206 which are laid out for easy viewing and comparison by the customer. Each of these proposed master itineraries may relate to the same general type of trip (e.g three different types of ski trips), or they may be totally different from each other based on the predictors that have been generated. Also shown is a criteria modification box 1208, which enables the customer at step 1012 to view and edit the travel criteria that he has previously entered in step 1002 above. Also provided is a keyword selection box 1210 which enables the customer to select certain keywords (or enter new ones if desired) that may be used to modify and/or refine the segments of the proposed master travel itineraries if desired. The main button 1212 enables the customer to go back to the main web page if desired. Also shown is a shuffle button 1214 which enables the customer to shuffle the proposed master itineraries, which could cause new proposed master itineraries to be generated, or which could cause segments that have been rejected by the customer to be replaced with alternate segments without changing the rest of the itinerary, or which could cause the proposed master itineraries to be revised based on travel criteria that has been modified via the criteria modification box 1208 and/or the keyword selection box 1210, all of which will be described in further detail below.

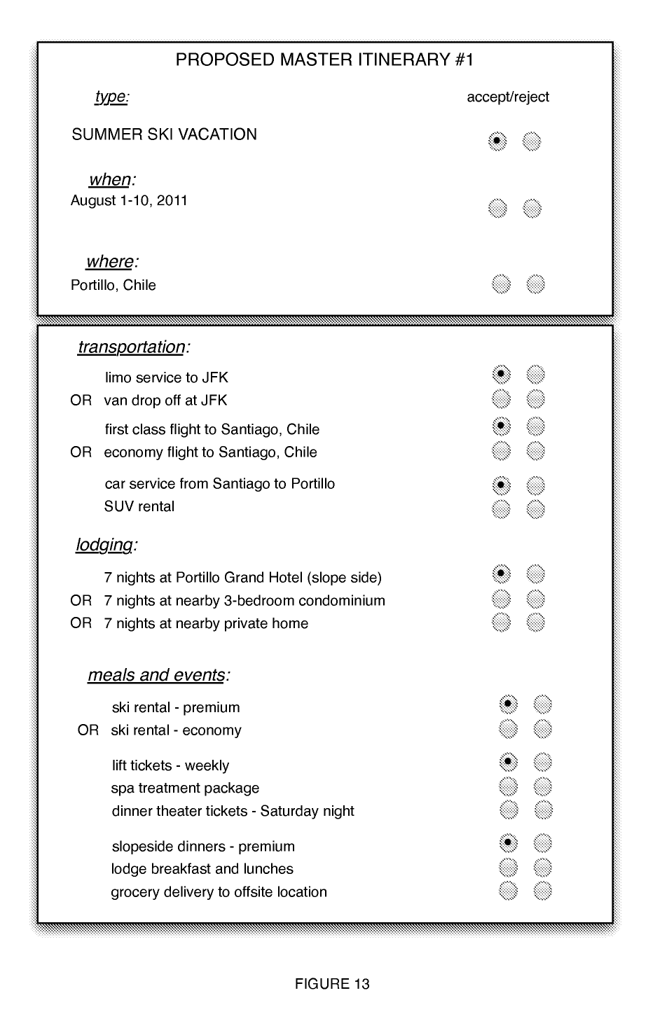

An exemplary proposed master itinerary 1202 is shown in detail in FIG. 13, and provides a listing of various travel segments that have been compiled by the master travel itinerary compiler 12d. As shown, the suggested vacation is for a summer ski vacation during Aug. 1-10, 2011 in Portillo, Chile. All of the recommended transportation, lodging, meal and event segments described above and listed in the Segment Table above have also been provided. Also provided for each item is a pair of radio buttons that allow the customer to either accept the segment or reject the segment. In this embodiment some of the accept buttons may be pre-selected and the customer would have to affirmatively select a reject button in order to reject an undesired segment; in alternative embodiments the reject buttons are pre-selected or neither button is pre-selected. The upper box in the proposed master travel itinerary shows three major options that control the display and availability of the segments in the lower box. The segments in the lower box are first presented on the assumption that the major options will be accepted by the customer. If any of these major options are not desired, in particular the type of vacation and the location, then the segments presented in the lower section will completely change since they are dependent on the type and location of the trip that will be taken. If the dates of the trip are changed, some or all of the segments on the lower box may change depending on the different time period that may be selected by the customer.

Assuming the customer accepts the major options presented of taking a ski trip to Portillo, Chile from Aug. 1-10, 2011, then the segments that were previously generated and stored in the Segment Table are laid out on the lower box of the web page shown in FIG. 13. Transportation segments 001 and 002 are provided as mutually exclusive options, since the customer needs to use a limo service or a van to get to and from the JFK airport. Also, transportation segments 003 and 004 are provided as mutually exclusive options, since the customer can only take a first class flight or an economy flight but not both. Optionally, all round trip segments may be split into one way segments so that the customer may take a first class flight one way and an economy flight in return, for example. The travel segments 005 and 006 are not necessarily mutually exclusive options, since the customer could have a van take him from SCL to the resort, and then rent an SUV just at the resort. Thus, he could select both these segments if desired. Similar selections are made by the customer of the remaining segments from the Segment Table.

Presentation of some segments may be dynamic and based on selection or rejection of other segments. For example, segment 017 (grocery delivery to offsite location) would not be applicable if the customer selects to stay at a slopeside resort without a kitchen facility. Therefore, this segment may be grayed out (or not even displayed) if the customer selects the slopeside lodging segment 007. Once he changes his selection to either segment 008 or 009, then the option to have food delivered would be selectable.

As the customer accepts and rejects various travel segments, the proposed master travel itinerary will be reshuffled so that only the accepted segments are shown, and/or new segments are presented that relate to the accepted segments. For example, if the customer selects the segment 007 to stay at the Portillo Grand Hotel, then new segment options may be retrieved from the segment table and displayed on the proposed master itinerary which relate to staying at that hotel (e.g. dinners, spa, shows, tours, concierge services, etc). The travel discovery and reservation computer then reconfigures and reshuffles the segment selection menu of the proposed master travel itineraries and presents them again to the customer. The process is continued and repeated until the customer is satisfied with one of the proposed master itineraries.

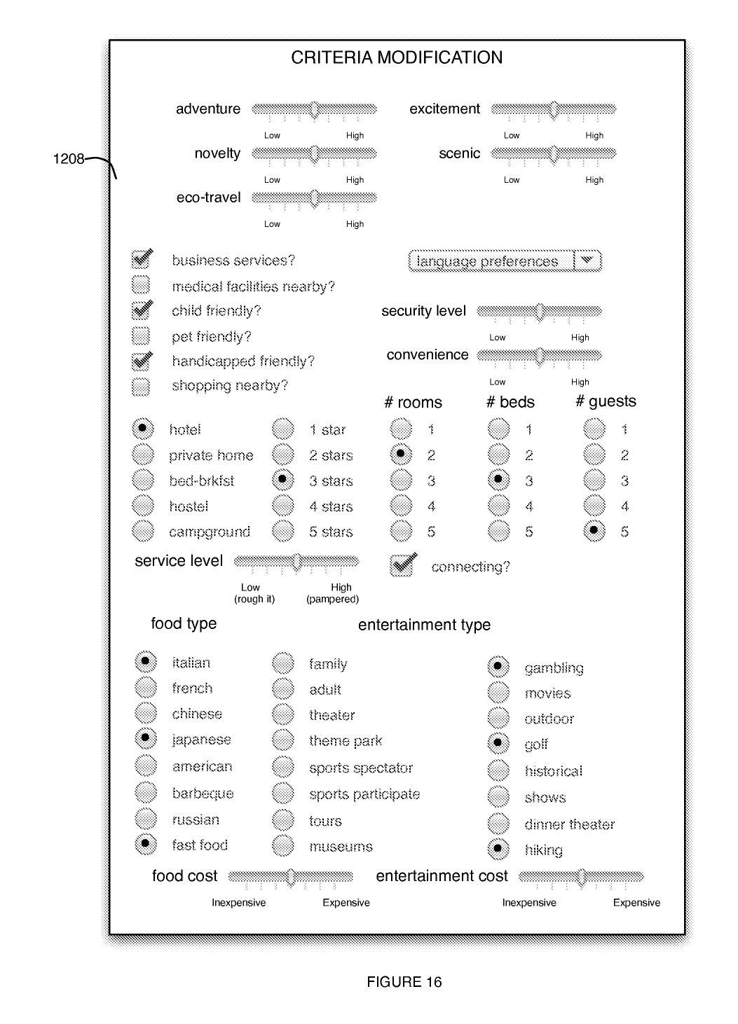

The travel discovery and reservation computer may also revise the proposed master travel itinerary(s) based on additional or revised criteria received from the customer computer. The criteria may be added or revised on the fly via the criteria modification box 1208 displayed on the web page. The criteria that was previously selected in step 1002 of FIG. 10 may be presented to the customer, and he is able to revise it on the fly by selecting various web controls as provided. FIG. 16 shows an exemplary embodiment of the criteria modification box 1208. As can be seen this is a compilation of the previously selected criteria, and may be scrolled down to display the criteria not shown. After each criteria selection is revised by the customer, the travel discovery and reservation computer generates new segments accordingly, and/or reorganizes and reshuffles the group of segment offers to include both new and updated opportunities based upon the improved or enlarged data set of criteria. The customer is able to instantly see the proposed itinerary change, on the fly, as he modifies the criteria in the modification box 1208.

Optionally, fees may be charged by the system based on various conditions, such as charging the customer a fee (e.g. $1) each time he requests a reshuffle of the itinerary, or a small fee for providing new or specialized criteria beyond a predefined standard package.

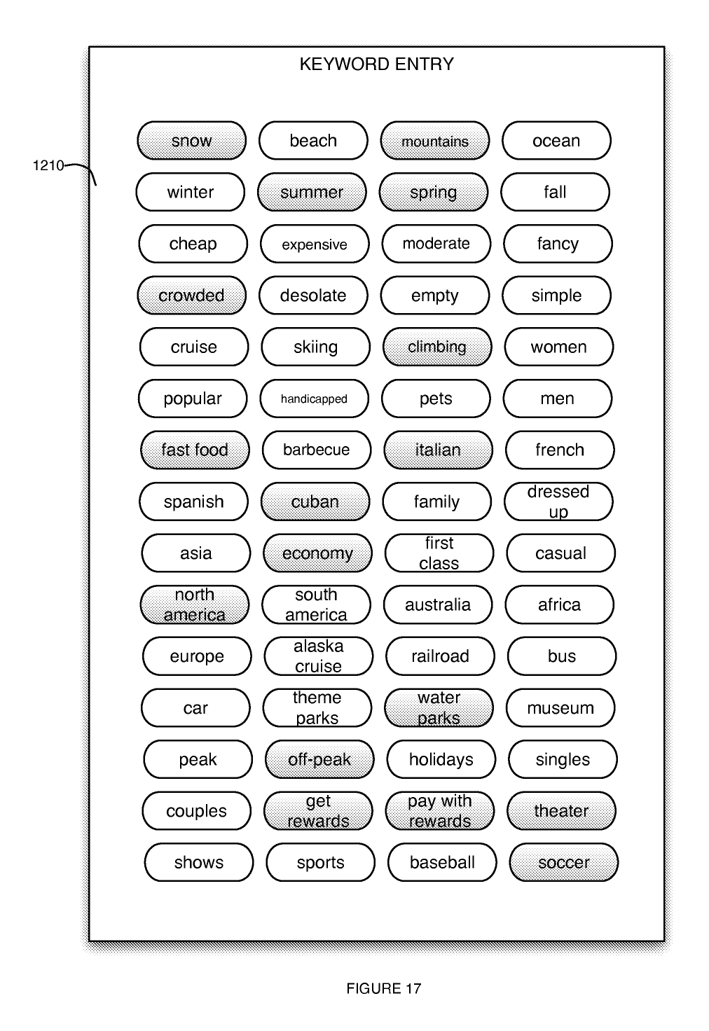

Similarly, the customer may select or enter keywords (also called tags) from a keyword selection box 1210 also provided on the web page 1200, which is used by the travel discovery and reservation computer to further revise the proposed master travel itinerary(s). An exemplary keyword selection box 1210 is shown in FIG. 17. Keywords are implemented similarly to criteria but offer a looser association selection process for the customer. He can quickly see interesting keywords and select them accordingly. After each new keyword is selected or de-selected by the customer, the travel discovery and reservation computer reorganizes and reshuffles the group of segment offers to include both new and updated opportunities based upon the improved or enlarged data set of keywords. In addition, there may a text input box provided so that the customer may enter new keywords or tags as desired, which would then be stored at the travel discovery and reservation computer 12 for later use by the customer or other customers.

As the customer accepts various travel segments from the master travel itinerary (or provides any other required inputs), the IDs of the accepted segments will be stored in a Master Itinerary Table as shown below:

Master Itinerary Table

| SEGMENT ID | SERVICE PROVIDER |
|---|---|
| 001 | ACME LIMO SERVICE |
| 001 | BETA LIMOS |
| 004 | UNITED |
| 004 | AMERICAN |
| 004 | JET BLUE |
| 006 | ENTERPRISE |
| 006 | AVIS |
| 006 | HERTZ |
| 007 | PORTILLO GRAND |
| 007 | MARRIOTT |
| 012 | PORTILLO SKI SHOP |

After the customer has gone through any number of iterations of itinerary review, segment acceptance and rejection, criteria modification, and/or keyword entry, will come to the point where he is provisionally satisfied with the proposed master itinerary, as revised, and will select the pricing button 1216. This will issue a request to the travel discovery and reservation computer 12 to begin the process of obtaining specific travel offers from various travel service provider computers, which will indicate among other things the price of the selected travel segments of the master itinerary.

Requests for Travel Offers from Travel Service Providers

Once the travel discovery and reservation computer 12 receives the indication that the customer has selected the pricing button 1216, it will undertake the process to obtain travel offers at step 1016 of FIG. 10. This process is undertaken by the bid/offer interaction module 12e as shown in FIG. 9. Through the bid/offer interaction module 12e, the travel discovery and reservation computer 12 will interact with the appropriate travel service provider computers 14 to request travel offers as needed.

The bid/offer interaction module 12e will reference the Master Itinerary Table and the Segment Table in order to determine, for each selected segment, which service providers could provide services for this trip. For example, the customer has selected segment 001, which is round trip limousine service from Greenwich, Conn. (his home) to JFK airport. Participating limousine services in the Greenwich area are looked up in a directory of participating service providers which has been previously compiled. These service providers would then be added as entries into the Master Itinerary Table, which in this example include Acme Limo Service and Beta Limos for segment 001. Similarly, the customer has selected segment 004, which is a round trip economy flight from JFK to Santiago, Chile (SCL). Participating airlines that provide flights between JFK and SCL would then be added as entries into the Master Itinerary Table, which in this example would be United, American Airlines, and Jet Blue. The service providers that can provide an appropriate service for the remaining segments chosen by the customer would also be populated into the Master Itinerary Table in the same manner as shown above. By referencing the Master Itinerary Table above, the travel discovery and reservation computer will generate a travel offer request that will be sent to the Acme Limo Service for segment 001 for ground transportation to take the user and his family from his home address in Greenwich, Conn. to JFK airport on the date of departure and return them on the return date. This request for an offer is also sent to the Beta Limos company. Similarly, the travel discovery and reservation computer will generate a travel offer request for segment 004 for a round trip economy flight from JFK to SCL, which is sent to UNITED, AMERICAN AIRLINES, and JET BLUE per the service provider column in the Master Travel and Offer Table above. Likewise, requests for travel offers fulfilling the remaining travel segments are sent to the associated service providers in accordance with the table above.

Each travel service provider computer that receives a request for a travel offer will process the offer as known in the art and send back to the travel discovery and reservation computer a travel offer at step 1018 in FIG. 10 that has information responsive to the request. The offers typically include the retail or standard price, a load factor, and any applicable comments. The offers are stored in an Offer Table 910 as shown in FIG. 9, a sample of which is provided below to illustrate several types of offers that may be received in the present example:

Offer Table 910

| | | | | | |
|---|---|---|---|---|---|
| | | | | | DIS- |
| | SERVICE | | | COM- | COUNTED |
| ID | PROVIDER | OFFER | LF | MENTS | OFFER |

| | | | | |
|---|---|---|---|---|
| 001 | ACME LIMO | $100 each | .40 | |
| | SERVICE | way | | |
| 001 | BETA | $125 each | .60 | |
| | LIMOS | way | | |
| 004 | UNITED | $600 per | .70 | FLT 1234 |
| | | person | | depart |
| | | | | 3:05 PM . . . |
| 004 | AMERICAN | $675 per | .55 | FLT 2345 |
| | | person | | depart |
| | | | | 2:45 PM . . . |
| 004 | JET BLUE | $500 per | .30 | FLT 33 |
| | | person | | depart |
| | | | | 10 PM . . . |
| 006 | ENTERPRISE | $700 per | .25 | Free ski |
| | | week - | | rack |
| | | minivan | | |
| 006 | AVIS | $650 per | .60 | GPS extra |
| | | week - SUV | | charge $50 |
| 006 | HERTZ | $500 per | .50 | |
| | | week - SUV | | |
| 007 | PORTILLO | $5,000 per | .80 | 2 rooms |
| | GRAND | week | | connecting, |
| | | | | slopeside |
| 007 | MARRIOTT | $4,000 per | .55 | Suite |
| | | week | | |
| 012 | PORTILLO | $1,500 per | N/A | 4 tickets for |
| | SKI SHOP | week | | 1 week each |

Thus, as shown a request for an air travel offer for segment ID 004 was sent to UNITED, AMERICAN, and JET BLUE, and each returned an offer with the price, flight details, and load factors (LF) as set forth in the table above. The load factor is a number that specifies how booked that travel segment is for that provider. For example, a load factor of 0.70 from the UNITED offer means that the flight is 70% booked. Similarly, a request for a car rental travel offer for segment 006 was sent to AVIS, HERTZ and ENTERPRISE, and each returned an offer with the price and load factors as set forth in the table above. The remaining travel offers are eventually received from the various service providers, and the travel discovery and reservation computer keeps track of these offers in the Offer Table 910 as set forth above.

### Discounted Offer Generation

Once the travel discovery and reservation computer has received the requested offers from the travel service provider computers 14, step 1020 of FIG. 10 is executed, in which a discounted offer generation process is executed by discount offer generation module 12f of the travel discovery and reservation computer 12 shown in FIG. 9. The travel discovery and reservation computer 12 may be programmed to generate a discounted offer as each offer arrives for a given segment, is stored in the Offer Table 910, or it may be programmed to wait until all offers have been received in the Offer Table 910 before executing the discount offer generation process 1020.

Either of three methodologies for implementing the discount offer generation process 1020 may be used by the travel discovery and reservation computer 12 in this invention. The first methodology is a static or table-driven process that references a predetermined discount rate table for the associated travel service provider computer 14 to retrieve a predetermined discount. The retrieved predetermined discount is then applied to the retail price stored in the Offer Table 910 to generate the discounted price, which is also then stored in the Offer Table 910. The predetermined discount obtained from the discount rate table may be calculated as a function of various parameters, including but not limited the associated load factor, the season or time of travel, the number of segments to be booked, the proximity of booking to expiration date and/or the desirability of the particular customer requesting the itinerary from the travel discovery and reservation computer. The second methodology is a dynamic or real-time interactive process in which a request for a real-time discount is transmitted to the travel service provider computer 14 associated that provided the travel offer. The real-time discount obtained from the travel service provider may similarly be calculated as a function of various parameters, including but not limited to the associated load factor, the season or time of travel, the number of segments to be booked, the proximity of booking to expiration date and/or the desirability of the particular customer requesting the itinerary from the travel discovery and reservation computer. The travel discovery and reservation computer then receives a real-time discount from the travel service provider computer, and it applies the received real-time discount to the retail price to generate the discounted price (or the actual discounted price is received directly from the travel service provider computer 14). In the third methodology, a combination of the static table-driven process and the dynamic real-time interactive process may be implemented.

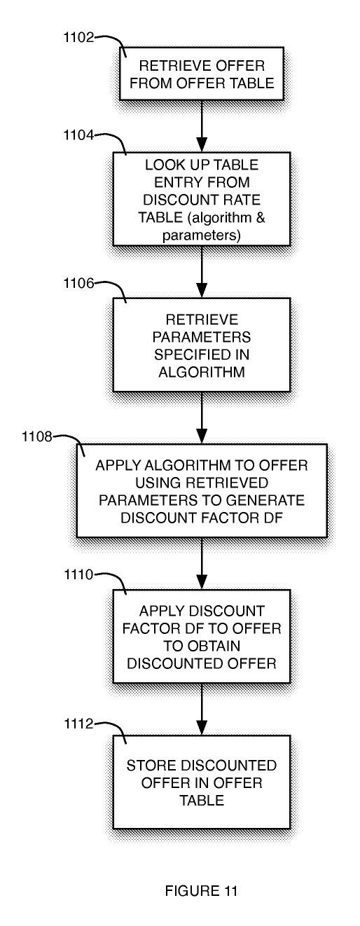

With reference to FIG. 11, which is a more detailed flowchart of step 1020, the static or table-driven process is now discussed. At step 1102, the non-discounted offer (retail offer) is retrieved from the offer table 910. At step 1104, a table entry associated with the service provider is looked up from the discount rate table 912 by the discount offer generation module 12f. In this static table-driven embodiment, the algorithm(s) used by the travel discovery and reservation computer 12 to calculate the discount for the offer from a given travel service provider computer is agreed to beforehand between the travel discovery and reservation computer 12 and that travel service provider computer, and stored in the discount rate table 912. Thus, for each service provider, there will be a table entry or entries that specify which parameter(s) should be used to calculate the discount factor as well as an algorithm that should be applied to the retail offer from that service provider in accordance with those discount parameters. The discount offer generation module 12e will retrieve an offer from the offer table 910 at step 1102, and then look up at step 1104 the table entry in discount rate table 912 for the service provider that submitted the offer, and then at step 1108 apply the algorithm from that table entry in accordance with the algorithm parameters retrieved at step 1106 in order to generate the discount factor DF for that offer. The discount factor DF is then applied at step 1110 to the retail offer in order to generate the discounted offer, which is stored at step 1112 in the Offer Table 910 as shown below:

Offer Table 910 - with discounts

| | | | | | DIS- |
|---|---|---|---|---|---|
| | SERVICE | | | COM- | COUNTED |
| ID | PROVIDER | OFFER | LF | MENTS | OFFER |
| 001 | ACME LIMO | $100 each | .40 | | $90 each |
| | SERVICE | way | | | way |
| 001 | BETA | $125 each | .60 | | $120 each |
| | LIMOS | way | | | way |
| 004 | UNITED | $600 per | .80 | FLT 1234 | $600 per |
| | | person | | depart | person |
| | | | | 3:05 PM . . . | |
| 004 | AMERICAN | $675 per | .55 | FLT 2345 | $600 per |
| | | person | | depart | person |
| | | | | 2:45 PM . . . | |
| 004 | JET BLUE | $500 per | .30 | FLT 33 | $350 per |
| | | person | | depart | person |
| | | | | 10 PM . . . | |
| 006 | ENTERPRISE | $800 per | .25 | Free ski | $600 per |
| | | week - | | rack | week |
| | | minivan | | | |
| 006 | AVIS | $650 per | .60 | GPS extra | $600 per |
| | | week - SUV | | charge $50 | week |
| 006 | HERTZ | $625 per | .50 | | $600 per |
| | | week - SUV | | | week |
| 007 | PORTILLO | $5,000 per | .80 | 2 rooms | $5,000 per |
| | GRAND | week | | connecting, | week |
| | | | | slopeside | |
| 007 | MARRIOTT | $4,000 per | .55 | Suite | $3,500 per |
| | | week | | | week |
| 012 | PORTILLO | $1,500 per | N/A | 4 tickets for | $1,500 per |
| | SKI SHOP | week | | 1 week each | week |

Thus, for example, the offer of $675 per person for the segment 004 flight on AMERICAN has now been discounted to $600 per person, using the load factor 0.55 in the discount algorithm. There was no discount applied to the offer from UNITED, since the load factor is relatively high and there was no need to provide a discount to that flight. As can be seen, the rental car prices quoted for segment 006 originally varied from each other, but the discount offers are all the same as a result of using the discount factor.

With reference to the dynamic or real-time interactive embodiment, the discount rate table 912 used in the static embodiment above is not utilized by the travel discovery and reservation computer 12 since the discounted offer will be generated by the travel service provider computers 14 referred to by the discount offer generation module 12e. In this dynamic real-time embodiment, algorithm(s) may be used by the travel service provider computers to calculate the discount for the offer in a manner similar to the static embodiment described above. In this case, the discounted offer will be provided by the travel service provider either at the time of providing the original offer or at any time thereafter if requested by the travel discovery and reservation computer 12. This may be an iterative process wherein the travel discovery and reservation computer 12 continues to query the travel service provider to provide an additional discount, which may be based on additional parameters or revised parameters such as a revised load factor (since load factors vary as new bookings are made). In a hybrid embodiment, the initial discounted offer may be generated by the discount offer generation module 12e using the static table-driven process described above, which may be supplemented by a real-time dynamic process in which the travel discovery and reservation computer 12 asks the service provider to provide an additional discount based on one or more various factors.

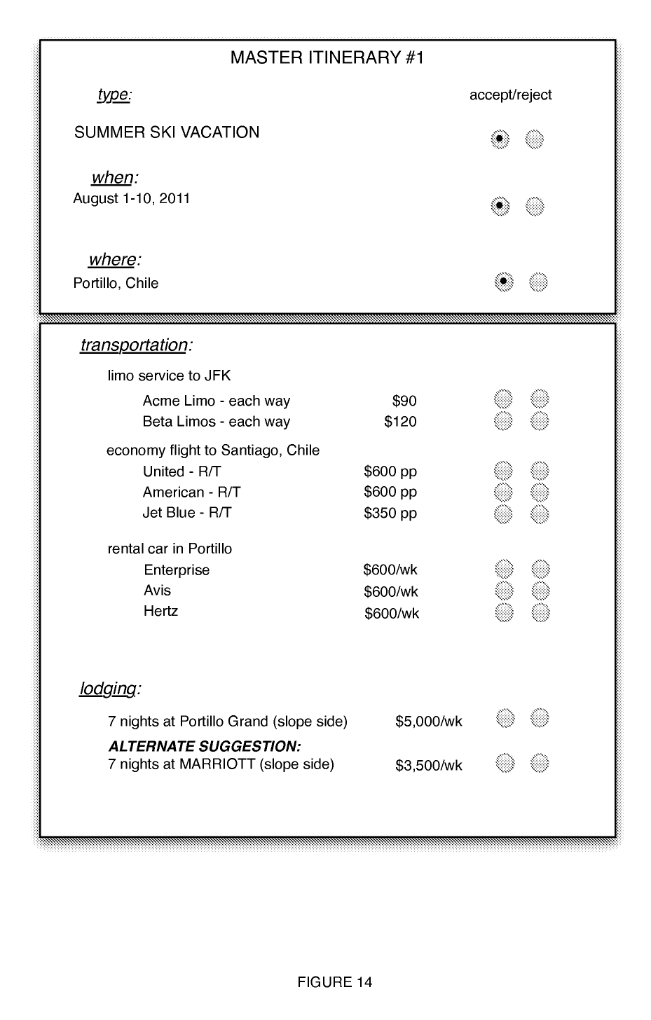

After or while the discounted offers are generated at step 1020, they are added to the master travel itinerary that is displayed at the customer computer for review and consideration by the customer. As shown in FIG. 14, the discounted prices may be provided for several travel service providers that were obtained by the travel discovery and reservation computer 12, so that he customer may make a selection on his own. Usually the customer would select the lowest offer, such as the Jet Blue flight and the Acme limo. However, other factors may be considered by the customer, such as a preference to use Beta Limos since they provide better service in his experience, or a preference to use American over Jet Blue since he knows he has reward points he can use to pay for that flight, etc. In addition, the travel discovery and reservation computer 12 may make alternative suggestions that may not have been initially selected by the customer, for example the highly discounted stay at the slopeside Marriott. As the customer makes his desired selections for each travel segment, a running total price may be displayed, which will change as segments are selected and/or rejected form the itinerary. As such, the customer has control over the total pricing and has real-time feedback as to the cost of his trip.

In an alternative embodiment, certain discounts may be provided that are time limited and the customer is informed of this so he may be urged to complete an itinerary sooner. This may be referred to with terms such as “Deal of the Day” and the like.

In an alternative embodiment, the travel discovery and reservation computer 12 may only provide one offer for each segment so that the customer is presented with a total package for immediate consideration without having to make any choices from the various offers. In this case, the travel discovery and reservation computer 12 would likely use the lowest discounted offer in preparing the master itinerary.

Optionally, the discounts provided by a travel service provider may vary as a function of the amount of discounts that have already been provided over a certain time period. For example, a travel service provider may require that no further discounts are given if more than a maximum number of discounts have already been provided, and it may vary the rate of discount if half the maximum number has been reached, etc.

In an alternative embodiment, the travel discovery and reservation computer may opt to obtain the travel offers from the service providers prior to presenting the proposed master travel itinerary to the customer, in order to provide the customer with more details (such as pricing) and help the customer make his initial segment selections. In this case, the travel discovery and reservation computer interacts with the travel service providers immediately after it has generated the travel predictors and generated the proposed master travel segments in order to obtain the travel offers, then generates the discounted travel offers and uses the discounted travel offers to compile the proposed master travel itinerary. This is shown by the dotted process line from step 1006 (generate proposed travel segments) to step 1016 (request travel offers) in FIG. 10. The customer may then choose the desired segments and specific offers and delete the undesired ones, and the travel discovery and reservation computer then reconfigures and reshuffles the offer selection menu of the proposed master travel itinerary and presents it again to the customer. The process is continued and repeated until the customer is satisfied with the master itinerary result. The customer may then select the booking button 1218 as shown in FIG. 12 to instruct the travel discovery and reservation computer to begin booking the segment reservations that have been accepted by the customer.

### Master Itinerary Modifications

The customer still has great control over the final itinerary that he may select. Optionally, the customer may reject one or more of the segment prices presented in the master itinerary proposed by the travel discovery and reservation computer. In this situation, the customer has an interest in the segment option presented but feels the price is too high. For example, the segment presented may be a museum tour with a price offered of $25 per person, and the customer may like the tour but only want to pay $15 per person. A third radio button option labelled “price reject” may be provided in FIG. 14. If the customer selects this option for any given segment offer, then the travel discovery and reservation computer may generate a price counteroffer for the rejected segment prices, and then send the price counteroffer to the associated travel service provider computer. The travel service provider computer may then either accept or reject the price counteroffer generated by the travel discovery and reservation computer. The travel discovery and reservation computer may then include any accepted price counteroffer in a revised master itinerary that is transmitted to the customer computer. In the alternative, the customer is able to provide to the travel discovery and reservation computer via the customer computer a price counteroffer for the rejected segment price of the master travel itinerary, and the travel discovery and reservation computer will then send the customer's price counteroffer to the associated travel service provider computer. The travel service provider computer may then either accept or reject the customer's price counteroffer provided by the travel discovery and reservation computer. The travel discovery and reservation computer may then include any accepted customer price counteroffer in a revised master itinerary that is transmitted to the customer computer. The customer may then accept that segment offer. In addition, the customer may, after receiving a discounted price generated by the table-driven method, request the travel service provider to provide an additional discount in real-time.

The customer may also reject a segment in its entirety if he does not like what is being offered by that segment. For example, if the segment offered is a museum tour, the customer may not want to go on the tour of the specified museum. If this occurs, the travel discovery and reservation computer after receiving these segment rejections may generate a segment alternative for the each of the rejected segments, and either present the segment alternative to the customer immediately, or first send the segment alternative to the appropriate travel service provider computer(s) and request an offer. The travel service provider computers may then provide an offer responsive to the request as set forth above. The travel discovery and reservation computer will then generate a discounted travel offer as also set forth above. The travel discovery and reservation computer will then add the discounted travel offers to the proposed master travel itinerary and transmits it to the customer computer for further review by the customer.

Optionally, the travel discovery and reservation computer may receive from the customer computer a request for an alternate master travel itinerary. In this case, the travel discovery and reservation computer will compile an alternate master travel itinerary that includes a different subset of the discounted travel offers, and then transmit the alternate master travel itinerary to the customer computer for review by the customer. If desired, the travel discovery and reservation computer may request alternate travel offers from the travel service provider computers for inclusion in the alternate master travel itinerary. After the travel discovery and reservation computer receives any alternate travel offers from the travel service provider computers, it will generate for each received alternate travel offer a discounted alternate travel offer having a discounted price as discussed above. The travel discovery and reservation computer will then use the discounted alternate travel offers for compiling the alternate master travel itinerary(s).

Once the customer wants to accept the proposed master itinerary, the customer computer will send the acceptance to the travel discovery and reservation computer. For each of the travel segment offers included in the accepted master travel itinerary, a reservation is made with the travel service provider computer that supplied the accepted offer. In the alternative to accepting the entire master itinerary, the customer may accept only selected segment options of the master travel itinerary. In this case, a reservation is made for each of the travel segment offers accepted by the customer with the associated travel service provider computer. Acceptance of a master travel itinerary and/or accepted segments thereof is controlled by selecting the button 1218 as shown in FIG. 12.

### Payment Processes

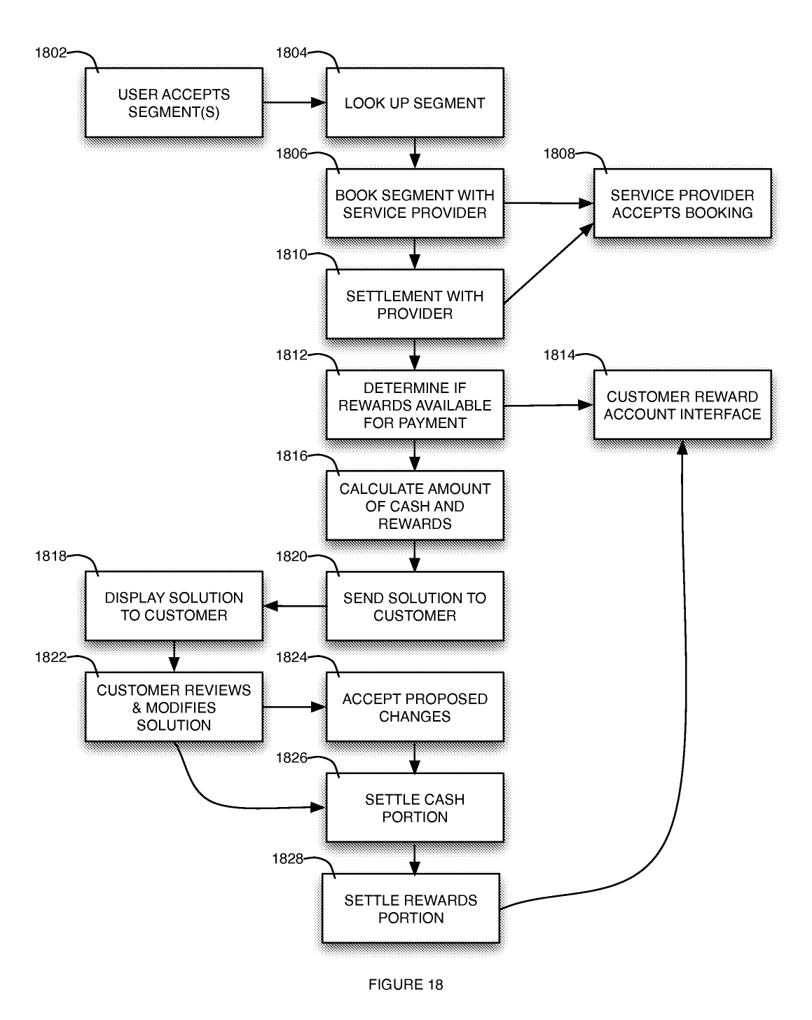

Once the customer has accepted a travel itinerary (or certain segments thereof), then the itinerary payment solutions module 12h of FIG. 2 is invoked by the accept and book itinerary step 1022 of FIG. 10. This process is shown in more detail in FIG. 18.

Once all of selected segment options of the master itinerary has been accepted by the customer at step 1802, a proposed itinerary payment solution associated with the master travel itinerary is generated by the travel discovery and reservation computer. The proposed itinerary payment solution may include a monetary portion and a promotional portion, wherein the monetary portion is payable by the customer with legal tender and the promotional portion payable is by the customer with promotional currency. For each accepted travel segment, the itinerary payment solutions module 12h looks up the details, in particular the service provider for that segment and an identification of the offer made by that service provider. The itinerary payment solutions module 12h then communicates with the appropriate service provider to confirm the booking at steps 1806 and 1808. Once confirmed, a settlement process is undertaken with the service provider as know in the art, such as by an existing account that the travel discovery and reservation computer 12 may have with that service provider, etc. This completes the booking of the segment with the travel service provider, and the next series of steps address payment by the customer to the travel discovery and reservation computer 12.

The itinerary payment solutions module 12h will first determine if the customer has any promotional currency available for making payment for the segment at step 1812. The promotional currency may include reward points, a coupon, or a rebate. In one embodiment, the customer would have a reward account 1814 stored on or in association with the travel discovery and reservation computer 12, which may be funded in various ways (such as when the customer books a trip through the travel discovery and reservation computer 12 he may receive reward points into his account redeemable for future trips as well known the art). In other embodiments, the reward points may be associated with other reward issuers or a trading service (as discussed further below). The itinerary payment module solutions module 12h would then calculate a proposed payment solution that specifies how many reward points that the customer may use (assuming enough are available in account 1814) towards payment of the booked segment, and how much legal tender (e.g via a credit card) would be required at a minimum. Algorithms, rules or formulas may be stored and referenced by the itinerary payment solutions module 12h in order to perform this calculation. For example, a rule may be used that requires a minimum of 50% to be paid by legal tender, or a rule may state that certain types of segments require certain legal tender minimums, etc). The calculation at step 1816 may also take into account the number of points available in the customer's reward account when specifying the cash minimum and point maximum.

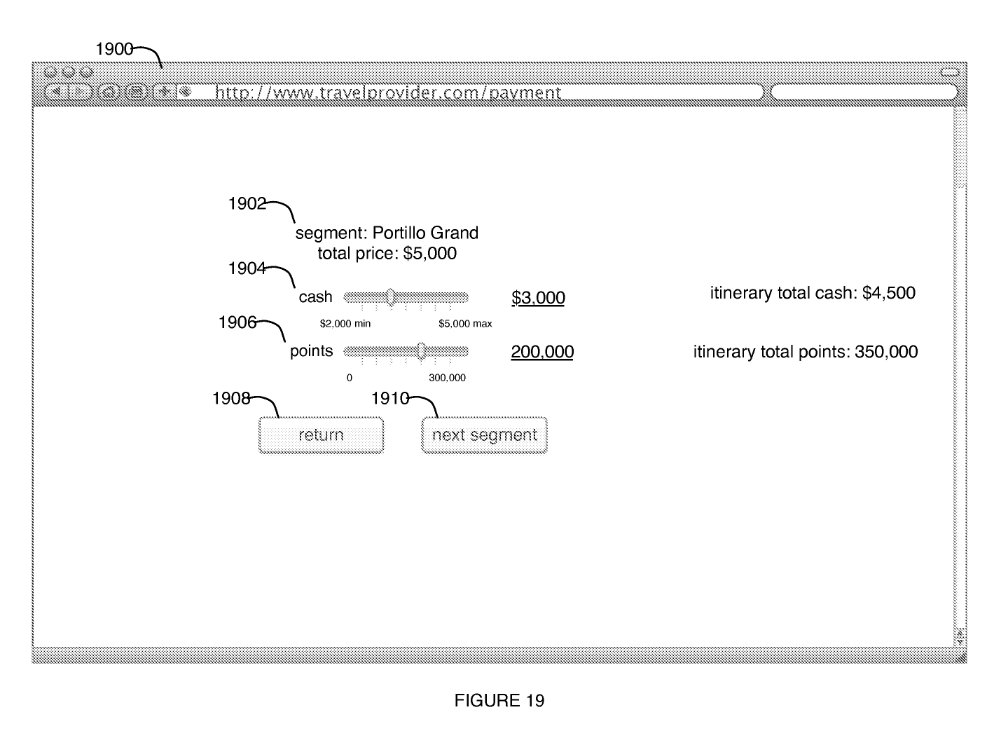

After being generated by the travel discovery and reservation computer 12, the proposed payment solution is sent at step 1820 to the customer computer for review by the customer. The payment solution is displayed to the customer at step 1818 for review and revision, if desired, at step 1822. The web page 1900 shown in FIG. 19 is an example of a payment solution display. Information on the travel segment is shown at box 1902 (description and segment price), and the proposed solution is displayed with slider controls 1904 and 1906. Cash slider control 1904 allows the customer to adjust the cash amount from a minimum amount as specified by the calculation in step 1816 to the total cost of the segment, which in this case is a minimum of $2,000 and a maximum (total cost) of $5,000 for the lodging segment at the Portillo Grand that was previously accepted by the customer. Cash refers to any legal tender including credit card payments as known in the art. The amount designated by the cash slider control 1904 is displayed next to it as shown. As the customer adjusts the cash slider control 1904, the corresponding number of reward points required to pay the balance will be displayed alongside the points slider control 1906, and the points slider control 1906 will be moved automatically to the point that corresponds to the points amount. Likewise, the customer may adjust the points slider control 1906, and the corresponding number of cash required to pay the balance will be displayed alongside the cash slider control 1904, and the cash slider control 1904 will be moved automatically to the point that corresponds to the cash amount. The minimum and maximum cash amounts, as well as the corresponding maximum and minimum points amounts, are determined by the calculation in step 1816 as previously described. In the example shown, the proposed payment solution is for the customer to pay $3,000 in cash and redeem 200,000 reward points (a par value of 1 penny per point). The customer may adjust the cash amount desired between $2,000 (the designated minimum) and $5,000 (the total cost of this segment), and the corresponding number of points required will also then be adjusted. Similarly, the customer could adjust the points amount desired between 300,000 (the designated maximum) and zero, and the corresponding amount of cash required will also then be adjusted. The calculation at step 1816 may take into account the number of points available in the customer's reward account when specifying the minimums and maximums. For example, if the customer only has 150,000 points in then account, then the points slider control 1906 is set to a 150,000 maximum and the cash slider control 1904 is set to a minimum corresponding amount of $3,500.

Also shown in FIG. 19 a return button 1908 that enables the customer to return to the master itinerary screen of FIG. 14 if desired. Also shown is a running total for the amount of cash and the number of points that the customer has already specified for all segments so far, which will help in the planning process. When the customer is satisfied with the proposed payment solution, then he may select the next segment button 1910 to continue the same process with the next segment of the master itinerary. At this point the itinerary payment solutions module 12h will accept the revisions and proceed to execute a cash settlement process at step 1826 and a reward points settlement process at step 1828. The cash settlement process will take the designated cash portion as indicated by the cash slider control 1904, and proceed the charge the customer's credit or debit card as well known in the art. The reward settlement process will cause the customer reward account 1814 to be reduced by the number of reward points designated by the points slider control 1906. Thus, the segment will now have been paid for and settled with the travel discovery and reservation computer 12 by the customer. The process will then return to step 1804 to book and pay for the next segment in the master travel itinerary, until all the accepted travel segments have been paid for. In an alternative embodiment, the total cost for all of the accepted segments of the entire master itinerary may be paid for at one time by the customer. In this case, steps 1804, 1806, 1808, and 1810 repeat for each travel service provider until all the segments have been booked and settled, as indicated by the dotted line 1830. Then the steps 1812 et seq. are executed, with the price provided to the customer being the total price of all segments in the itinerary. Thus, the customer would be provided with one proposed payment solution for the entire itinerary, would review and revise the total payment solution, and settle (cash and reward points) the total payment in one single process.

In an alternative embodiment, the travel discovery and reservation computer 12 may function to enable the customer to pay the service provider directly for any or all of the booked segments, rather than paying the service provider on the customer's behalf and then collecting the payment from the customer as in the above embodiment. This is particularly advantageous in the event that the customer wants to redeem reward points from a reward account the customer already has with the service provider in order to pay for a segment from that service provider. In this process, the itinerary payment solutions module 12h will request the service provider computer 14 to inform it as to the number of reward points the customer has in a reward account with that service provider computer and how many points of those points the customer may redeem towards payment for that segment. Then, the service provider settlement step 1810 will be skipped, and the proposed payment solution for that segment will be calculated at step 1816, using the reward point information from the travel service provider rather than from an account 1814 the customer may have on the travel discovery and reservation computer 12. After the customer is presented with the proposed payment solution using the travel service provider's reward points and/or cash, and then revises and/or accepts the solution, then the cash settlement step 1826 and rewards settlement step 1828 are undertaken with the travel service provider so that the reward account that the customer has with the travel service provider is reduced by the amount designated in the payment solution, and the cash portion is paid for by a credit or debit card directly with the travel service provider. For example, if the customer has accepted a travel segment for a flight from Jet Blue costing $500, then he has 50,000 points in his Jet Blue reward account that Jet Blue will allow him to use to pay for the trip completely, then this process will manage the flight booking and Jet Blue points redemption so the customer is able to pay for the flight with his Jet Blue points via the travel discovery and reservation computer 12.

In the embodiment described above, the customer reward account 1814 is typically funded with reward points that are earned as a result of booking trips with the travel discovery and reservation computer 12, as well known in the art. For example, if the customer spend $5,000 on trip, he may receive 5000 reward points that are redeemable for future bookings. In addition, the customer's reward account may be a reward exchange account, which may be funded with reward points that are exchanged from other reward accounts with other reward issuers. This process is fully described in my prior U.S. Pat. No. 6,594,640, entitled SYSTEM FOR ELECTRONIC BARTER, TRADING AND REDEEMING POINTS ACCUMULATED IN FREQUENT USE REWARD PROGRAMS, which is incorporated by reference herein. This enables the customer to use reward points from issuers who may not be providing travel services to the customer to be exchanged into the customer's reward account, which acts as an exchange account as described in the '640 patent. In another embodiment, reward points may be redeemed in real time from reward issuers at the time the segments are booked and paid for, as described in my co-pending U.S. application Ser. No. 12/703,243 entitled ONLINE REWARD POINT EXCHANGE METHOD AND SYSTEM, the specification of which is incorporated by reference herein. The customer may in this embodiment be presented with various controls that enable him to specify how many points would be redeemed from which reward issuers in order to pay for any given travel segment being booked (or to pay for the trip in its entirety if desired.

### Social Networking

In another aspect of the invention involving social networking travel components, the travel criteria entered by the customer, the preferences stored for the customer, and optionally any itinerary revision keywords selected by the customer are used to generate a travel profile that is stored on the travel discovery and reservation computer 12. This travel profile may be compared to other stored travel profiles of other customers of the travel discovery and reservation computer 12. Those customers having similar travel profiles may be matched so that they are offered similar travel itineraries having some segments that are matched to each other so that these matched customers may be able to meet each other at that time. For example, the travel discovery and reservation computer may match two different customers by placing them on the same ski trip, and then providing a means for these customers to meet each other during the ski trip, such as by organizing a group meeting or the like.

### Ratings

In addition, the customer is able to re-enter the system after he has completed his trip, and provide feedback in the form of ratings for each segment of the trip and/or the service provider for that segment. When the rating system is used, it will also be made available to the customer during the itinerary reservation phase, wherein ratings of segments and the associated service providers are accessible to the customer, which may be limited to only those ratings from people in the customer's social network(s).

In an alternative embodiment, the travel discovery and reservation computer may also compute the percentages of use or value to the consumer for segmenting values, commissions or other forms of compensation of tracking mechanisms on behalf of services providers or their agents. This system may partition or allocate values which are then assigned to the use of data which may be used for marketing or advertising purposes which will then determine the revenue sharing capability of the contributors.

Also, there may be a broadcast or game show application in which contestants play against or with the computer assessing their selections and where the viewing audience makes selections or suggestions. Consumers or players then must take the trip or selected itinerary and are judged or judge the result. Viewers can win trips or participation on the show from making correct assertions or predictions about travel or travel results. Consumers or viewers act as “virtual travel” agents.

What is claimed is:

1. A computer-implemented method of a travel discovery and reservation computer generating a master travel itinerary for a customer comprising the steps of:
sending to a customer computer a web page comprising a plurality of input controls for inputting a plurality of travel criteria,
receiving from the customer computer a plurality of travel criteria input by a customer via the web page;
analyzing the travel criteria provided by the customer computer to generate a set of predictors that recommend at least one proposed travel itinerary that satisfies the travel criteria;
generating a plurality of proposed travel segments, each of the proposed travel segments associated with a different part of the proposed travel itinerary,
sending the proposed travel segments to the customer computer for acceptance or rejection by the customer;
receiving an indication from the customer computer as to which of the proposed travel segments are accepted;
compiling a master travel itinerary comprising the accepted travel segments, and
sending the master travel itinerary to the customer computer.

2. The method of claim 1 further comprising, for each accepted travel segment, transmitting to at least one travel service provider computer a request for a travel offer related to the accepted travel segment.

3. The method of claim 2 further comprising receiving from each requested travel service provider computer a travel offer responsive to the request specifying a retail price normally charged for the accepted travel segment and a load factor associated with the accepted travel segment.

4. The method of claim 3 further comprising generating, for each received travel offer, a discounted travel offer having a discounted price less than the retail price normally charged for the accepted travel segment.

5. The method of claim 4 wherein the step of generating, for each received travel offer, a discounted travel offer having a discounted price less than the retail price normally charged for the accepted travel segment comprises:
referencing a predetermined load factor discount rate table for the associated travel service provider computer to retrieve a predetermined discount for the associated load factor, and
applying the retrieved predetermined discount to the retail price to generate the discounted price.

6. The method of claim 4 wherein the step of generating, for each received travel offer, a discounted travel offer having a discounted price less than the retail price normally charged for the accepted travel segment comprises:
transmitting, to the travel service provider computer that provided the travel offer, a request for a discount;
receiving a real-time discount from the travel service provider computer; and
applying the received real-time discount to the retail price to generate the discounted price.

7. The method of claim 4 wherein the discounted price is generated based on the season of travel in the travel offer.

8. The method of claim 4 wherein the discounted price is generated based on the proximity to an expiration date of the travel offer.

9. The method of claim 4 wherein the discounted price is generated based on a desirability factor of the customer.

10. The method of claim 4 further comprising including at least one discounted travel offer for each accepted travel segment in the master travel itinerary sent to the customer computer.

11. The method of claim 10 comprising the further step of receiving from the customer computer, for each accepted travel segment, an acceptance of a discounted travel offer associated with the accepted travel segment of the master travel itinerary.

12. The method of claim 11 comprising the further steps of:
for each accepted segment offer, generating a proposed payment solution comprising a monetary portion and a promotional portion, the monetary portion payable by the customer with legal tender and the promotional portion payable by the customer with promotional currency; and
transmitting the proposed itinerary payment solution to the customer computer for review by the customer.

13. The method of claim 12 wherein the monetary portion is a minimum monetary portion that specifies a minimum amount of legal tender required.

14. The method of claim 12 wherein the promotional currency comprises reward points, a coupon, or a rebate.

15. The method of claim 12 further comprising the steps of:
receiving customer acceptance of the proposed payment solution, and
causing payment to be made in accordance with the monetary portion and the promotional portion of the proposed payment solution.

16. The method of claim 12 further comprising the steps of:
receiving from the customer computer a modified payment solution, and
causing payment to be made in accordance with the monetary portion and the promotional portion of the modified payment solution.

17. The method of claim 10 further comprising the steps of
receiving from the customer computer a request for an alternate travel offers;
requesting alternate travel offers from associated travel service provider computers,
receiving from each of the travel service provider computers an alternate travel offer,
generating, for each received alternate travel offer, a discounted alternate travel offer having a discounted price; and
presenting the discounted alternate travel offers to the customer computer.

18. The method of claim 10 comprising the further step of receiving from the customer computer, for each accepted travel segment, a rejection of a discounted travel offer associated with the accepted travel segment of the master travel itinerary.

19. The method of claim 18 comprising the further steps of
generating a counteroffer for the each of the rejected discounted travel offers; and
sending the counteroffers to each of the associated travel service provider computers.

20. The method of claim 19 comprising the further steps of
receiving from each of the associated travel service provider computers an acceptance or rejection of the counteroffers generated by the travel discovery and reservation computer, and
sending the accepted counteroffers to the customer computer.

21. The method of claim 18 comprising the further steps of
receiving from the customer a counteroffer for the each of the rejected segments of the discounted travel offers; and
sending the counteroffers to each of the associated travel service provider computers.

22. The method of claim 21 comprising the further steps of
receiving from each of the associated travel service provider computers an acceptance or rejection of the counteroffers made by the customer, and
sending the accepted counteroffers to the customer computer.

23. The method of claim 1 further comprising, for each proposed travel segment, transmitting to at least one travel service provider computer a request for a travel offer related to the proposed travel segment.

24. The method of claim 23 further comprising receiving from each requested travel service provider computer a travel offer responsive to the request specifying a retail price normally charged for the proposed travel segment and a load factor associated with the proposed travel segment.

25. The method of claim 24 further comprising generating, for each received travel offer, a discounted travel offer having a discounted price less than the retail price normally charged for the proposed travel segment.

26. The method of claim 1 further comprising:
providing criteria modification input controls alongside the proposed travel segments at the customer computer,
receiving modified or additional criteria from the criteria modification input controls at the customer computer,
generating a new set of proposed travel segments based on the modified or additional criteria, and
sending the new set of proposed travel segments to the customer computer for acceptance or rejection by the customer.

27. The method of claim 1 further comprising:
providing keyword input controls alongside the proposed travel segments at the customer computer,
receiving selected keyword inputs from the keyword input controls at the customer computer,
generating a new set of proposed travel segments based on the received keyword, and
sending the new set of proposed travel segments to the customer computer for acceptance or rejection by the customer.

28. The method of claim 1 further comprising the steps of receiving from the customer computer a request for an alternate master travel itinerary, and sending an alternate set of proposed travel segments to the customer computer for acceptance or rejection by the customer.

29. The method of claim 1 further comprising the step of storing in memory one or more master travel itineraries for subsequent retrieval and review by the customer.

30. The method of claim 1 comprising the further step of receiving from the customer computer a selection of proposed segments of the master travel itinerary in which the customer has indicated an interest.

31. The method of claim 30 further comprising the step of providing a shuffle control to the customer computer enabling the customer to retrieve additional or replacement proposed segments to supplement the selection of proposed segments in which the customer has indicated an interest.

32. The method of claim 1 wherein previously stored preferences of the customer is additionally used by the travel discovery and reservation computer to generate the set of predictors.

33. The method of claim 32 wherein the preferences are provided by the customer computer during a registration process.

34. The method of claim 32 wherein the preferences are determined by analyzing previously entered travel criteria.

35. The method of claim 32 wherein the preferences are obtained from external sources.

36. The method of claim 1 wherein a plurality of previously stored preference files associated with a group of customers are additionally used by the travel discovery and reservation computer to generate the set of predictors.

37. The method of claim 1 wherein the criteria provided by the customer overrides the previously stored preference file of the customer.

38. The method of claim 1 wherein a previously stored travel history of the customer is additionally used by the travel discovery and reservation computer to generate the set of predictors.

39. The method of claim 1 wherein the input controls comprise a slider control.

40. The method of claim 1 wherein the input controls comprise a plurality of radio buttons.

41. The method of claim 1 wherein the input controls comprise a plurality of check boxes.

42. The method of claim 1 wherein the criteria comprise a budget amount criteria specifying the amount of money the customer is willing to pay for the master travel itinerary.

43. The method of claim 1 wherein the criteria comprise a desired travel time criteria when the customer desires to travel.

44. The method of claim 43 wherein the desired travel time comprises a desired beginning date and a desired end date.

45. The method of claim 43 wherein the desired travel time comprises a desired season.

46. The method of claim 43 wherein the desired travel time comprises a desired length of time.

47. The method of claim 43 wherein the desired travel time is an open travel option.

48. The method of claim 1 wherein the criteria comprise a desired travel location criteria specifying where the customer would like to travel.

49. The method of claim 48 wherein the desired travel location comprises a desired geographic region.

50. The method of claim 48 wherein the desired travel location comprises a desired climate.

51. The method of claim 48 wherein the desired travel location comprises a desired type of location.

52. The method of claim 1 wherein the criteria comprise a travel type criteria specifying the type of travel the customer would like to experience.

53. The method of claim 52 wherein the travel type criteria enables the customer to indicate a level of adventure.

54. The method of claim 52 wherein the travel type criteria enables the customer to indicate a level of novelty.

55. The method of claim 52 wherein the travel type criteria enables the customer to indicate a level of incontinence.

56. The method of claim 52 wherein the travel type criteria enables the customer to indicate a level of pampering.

57. The method of claim 52 wherein the travel type criteria enables the customer to indicate a level of service quality.

58. The method of claim 52 wherein the travel type criteria enables the customer to indicate a level of food quality.

59. The method of claim 52 wherein the travel type criteria enables the customer to indicate a level of local content importance.

60. The method of claim 52 wherein the travel type criteria enables the customer to indicate a level of eco-travel importance.

61. The method of claim 52 wherein the travel type criteria enables the customer to indicate a level of excitement.

62. The method of claim 52 wherein the travel type criteria enables the customer to indicate a level of human interaction importance.

63. The method of claim 52 wherein the travel type criteria enables the customer to indicate a type of interaction.

64. The method of claim 52 wherein the travel type criteria enables the customer to indicate a level of shopping.

65. The method of claim 52 wherein the travel type criteria enables the customer to indicate a level of entertainment.

66. The method of claim 52 wherein the travel type criteria enables the customer to indicate a level of convenience.

67. The method of claim 52 wherein the travel type criteria enables the customer to indicate a type of view from a hotel room.

68. The method of claim 52 wherein the travel type criteria enables the customer to indicate a level of proximity to predefined facilities including a beach, a pool, a restaurant, and an entrance.

69. The method of claim 52 wherein the travel type criteria enables the customer to indicate a level of security.

70. The method of claim 52 wherein the travel type criteria enables the customer to indicate a level of child friendly elements.

71. The method of claim 52 wherein the travel type criteria enables the customer to indicate a level of pet friendly elements.

72. The method of claim 52 wherein the travel type criteria enables the customer to indicate a level of handicapped facilities.

73. The method of claim 52 wherein the travel type criteria enables the customer to indicate a level of medical facilities.

74. The method of claim 52 wherein the travel type criteria enables the customer to indicate the desirability of obtaining connecting rooms.

75. The method of claim 52 wherein the travel type criteria enables the customer to indicate the desirability of obtaining a private villa.

76. The method of claim 52 wherein the travel type criteria enables the customer to indicate the desirability of obtaining a specified number of beds.

77. The method of claim 52 wherein the travel type criteria enables the customer to indicate the number of people that will travel.

78. The method of claim 52 wherein the travel type criteria enables the customer to indicate a level of language translation.

79. The method of claim 52 wherein the travel type criteria enables the customer to indicate the desirability of obtaining business services including secretarial, video conferencing, telephone service, internet connectivity.

80. The method of claim 3 wherein at least one of the travel service provider computers is a transportation provider computer, and wherein the travel offer received from the transportation provider computer specifies a travel segment that provides transportation that is responsive to the request by the travel discovery and reservation computer.

81. The method of claim 80 wherein the transportation provider computer is an airline flight reservation computer, and wherein the travel offer received from the airline flight reservation computer specifies a travel segment of an airline flight responsive to the request by the travel discovery and reservation computer.

82. The method of claim 80 wherein the transportation provider computer is a railroad reservation computer, and wherein the travel offer received from the railroad reservation computer specifies a travel segment of an railroad trip responsive to the request by the travel discovery and reservation computer.

83. The method of claim 80 wherein the transportation provider computer is an automobile rental reservation computer, and wherein the travel offer received from the automobile rental reservation computer specifies a travel segment of an automobile rental responsive to the request by the travel discovery and reservation computer.

84. The method of claim 3 wherein at least one of the travel service provider computers is a lodging service provider computer, and wherein the travel offer received from the lodging service provider computer specifies a travel segment that provides lodging that is responsive to the request by the travel discovery and reservation computer.

85. The method of claim 84 wherein the lodging service provider computer is a hotel reservation computer, and wherein the travel offer received from the hotel reservation computer specifies a travel segment of a hotel room reservation responsive to the request by the travel discovery and reservation computer.

86. The method of claim 3 wherein at least one of the travel service provider computers is a meal service provider computer, and wherein the travel offer received from the meal service provider computer specifies a travel segment that provides meals that is responsive to the request by the travel discovery and reservation computer.

87. The method of claim 3 wherein at least one of the travel service provider computers is an event service provider computer, and wherein the travel offer received from the event service provider computer specifies a travel segment of a reservation for an event responsive to the request by the travel discovery and reservation computer.

88. The method of claim 87 wherein the event service provider computer is a theme park reservation computer, and wherein the travel offer received from the theme park reservation computer specifies a travel segment of a theme park admission responsive to the request by the travel discovery and reservation computer.

89. The method of claim 87 wherein the event service provider computer is a theater reservation computer, and wherein the travel offer received from the theater reservation computer specifies a travel segment of a theater admission responsive to the request by the travel discovery and reservation computer.

90. The method of claim 87 wherein the event service provider computer is a sporting event service provider computer, and wherein the travel offer received from the sporting event service provider computer specifies a travel segment of a sporting event admission responsive to the request by the travel discovery and reservation computer.

91. The method of claim 87 wherein the event service provider computer is a tour group reservation computer, and wherein the travel offer received from the tour group reservation computer specifies a travel segment of a tour group admission responsive to the request by the travel discovery and reservation computer.

92. The method of claim 3 wherein at least one of the travel service provider computers is a third party aggregator reservation computer, and wherein the travel offer received from the third party aggregator reservation computer specifies any of the following: a travel segment of a transportation reservation responsive to the request by the travel discovery and reservation computer, a lodging reservation responsive to the request by the travel discovery and reservation computer, a meals reservation responsive to the request by the travel discovery and reservation computer, or an event reservation for an event responsive to the request by the travel discovery and reservation computer

93. A travel discovery and reservation system for generating a master travel itinerary for a customer comprising:
A. a customer computer;
B. a travel discovery and reservation computer interconnected with the customer computer via at least one network; and
C. a plurality of travel service provider computers interconnected with the travel discovery and reservation computer via at least one network;
wherein the travel discovery and reservation computer is programmed to:
send to a customer computer a web page comprising a plurality of input controls for inputting a plurality of travel criteria,
receive from the customer computer a plurality of travel criteria input by a customer via the web page;
analyze the travel criteria provided by the customer computer to generate a set of predictors that recommend at least one proposed travel itinerary that satisfies the travel criteria;
generate a plurality of proposed travel segments, each of the proposed travel segments associated with a different part of the proposed travel itinerary,
send the proposed travel segments to the customer computer for acceptance or rejection by the customer;
receive an indication from the customer computer as to which of the proposed travel segments are accepted;
compile a master travel itinerary comprising the accepted travel segments, and
send the master travel itinerary to the customer computer.

94. The system of claim 93, wherein the travel discovery and reservation computer is further programmed to, for each accepted travel segment, transmit to at least one travel service provider computer a request for a travel offer related to the accepted travel segment.

95. The system of claim 94, wherein the travel discovery and reservation computer is further programmed to receive from each requested travel service provider computer a travel offer responsive to the request specifying a retail price normally charged for the accepted travel segment and a load factor associated with the accepted travel segment.

96. The system of claim 95, wherein the travel discovery and reservation computer is further programmed to generate, for each received travel offer, a discounted travel offer having a discounted price less than the retail price normally charged for the accepted travel segment.

97. The system of claim 96, wherein the travel discovery and reservation computer is programmed to generate, for each received travel offer, a discounted travel offer having a discounted price less than the retail price normally charged for the accepted travel segment by:
referencing a predetermined load factor discount rate table for the associated travel service provider computer to retrieve a predetermined discount for the associated load factor, and
applying the retrieved predetermined discount to the retail price to generate the discounted price.

98. The system of claim 96, wherein the travel discovery and reservation computer is programmed to generate, for each received travel offer, a discounted travel offer having a discounted price less than the retail price normally charged for the accepted travel segment by:
transmitting, to the travel service provider computer that provided the travel offer, a request for a discount;
receiving a real-time discount from the travel service provider computer; and
applying the received real-time discount to the retail price to generate the discounted price.

99. The system of claim 96, wherein the travel discovery and reservation computer is programmed to include at least one discounted travel offer for each accepted travel segment in the master travel itinerary sent to the customer computer.

100. The system of claim 99, wherein the travel discovery and reservation computer is programmed to receive from the customer computer, for each accepted travel segment, an acceptance of a discounted travel offer associated with the accepted travel segment of the master travel itinerary.

101. The system of claim 100, wherein the travel discovery and reservation computer is programmed to:
for each accepted segment offer, generate a proposed payment solution comprising a monetary portion and a promotional portion, the monetary portion payable by the customer with legal tender and the promotional portion payable by the customer with promotional currency; and
transmit the proposed itinerary payment solution to the customer computer for review by the customer.

102. The system of claim 101, wherein the travel discovery and reservation computer is programmed to:
receive customer acceptance of the proposed payment solution, and
cause payment to be made in accordance with the monetary portion and the promotional portion of the proposed payment solution.

103. The system of claim 101, wherein the travel discovery and reservation computer is programmed to:
receive from the customer computer a modified payment solution, and
cause payment to be made in accordance with the monetary portion and the promotional portion of the modified payment solution.

104. The system of claim 99, wherein the travel discovery and reservation computer is programmed to receive from the customer computer, for each accepted travel segment, a rejection of a discounted travel offer associated with the accepted travel segment of the master travel itinerary.

105. The system of claim 104, wherein the travel discovery and reservation computer is programmed to
generate a counteroffer for the each of the rejected discounted travel offers; and
send the counteroffers to each of the associated travel service provider computers.

106. The system of claim 105, wherein the travel discovery and reservation computer is programmed to
receive from each of the associated travel service provider computers an acceptance or rejection of the counteroffers generated by the travel discovery and reservation computer, and
send the accepted counteroffers to the customer computer.

107. The system of claim 104, wherein the travel discovery and reservation computer is programmed to
receive from the customer a counteroffer for the each of the rejected segments of the discounted travel offers; and
send the counteroffers to each of the associated travel service provider computers.

108. The system of claim 107, wherein the travel discovery and reservation computer is programmed to
receive from each of the associated travel service provider computers an acceptance or rejection of the counteroffers made by the customer, and
send the accepted counteroffers to the customer computer.

109. The system of claim 93, wherein the travel discovery and reservation computer is programmed to, for each proposed travel segment, transmit to at least one travel service provider computer a request for a travel offer related to the proposed travel segment.

110. The system of claim 109, wherein the travel discovery and reservation computer is programmed to receive from each requested travel service provider computer a travel offer responsive to the request specifying a retail price normally charged for the proposed travel segment and a load factor associated with the proposed travel segment.

111. The system of claim 110, wherein the travel discovery and reservation computer is programmed to generate, for each received travel offer, a discounted travel offer having a discounted price less than the retail price normally charged for the proposed travel segment.

112. The system of claim 93, wherein the travel discovery and reservation computer is programmed to
provide criteria modification input controls alongside the proposed travel segments at the customer computer,
receive modified or additional criteria from the criteria modification input controls at the customer computer,
generate a new set of proposed travel segments based on the modified or additional criteria, and
send the new set of proposed travel segments to the customer computer for acceptance or rejection by the customer.

113. The system of claim 93, wherein the travel discovery and reservation computer is programmed to
provide keyword input controls alongside the proposed travel segments at the customer computer,
receive selected keyword inputs from the keyword input controls at the customer computer,
generate a new set of proposed travel segments based on the received keyword, and
send the new set of proposed travel segments to the customer computer for acceptance or rejection by the customer.

114. The system of claim 93, wherein the travel discovery and reservation computer is programmed to receive from the customer computer a request for an alternate master travel itinerary, and send an alternate set of proposed travel segments to the customer computer for acceptance or rejection by the customer.

115. The system of claim 93, wherein the travel discovery and reservation computer is programmed to store in memory one or more master travel itineraries for subsequent retrieval and review by the customer.

116. The system of claim 93, wherein the travel discovery and reservation computer is programmed to receive from the customer computer a selection of proposed segments of the master travel itinerary in which the customer has indicated an interest.

117. The system of claim 116, wherein the travel discovery and reservation computer is programmed to provide a shuffle control to the customer computer enabling the customer to retrieve additional or replacement proposed segments to supplement the selection of proposed segments in which the customer has indicated an interest.

118. The system of claim 93, wherein the travel discovery and reservation computer is programmed to additionally use previously stored preferences of the customer to generate the set of predictors.

119. The system of claim 118, wherein the travel discovery and reservation computer is programmed to store the preferences provided by the customer computer during a registration process.

120. The system of claim 118, wherein the travel discovery and reservation computer is programmed to determined the preferences by analyzing previously entered travel criteria.

121. The system of claim 118, wherein the travel discovery and reservation computer is programmed to obtain the preferences from external sources.

122. The system of claim 93, wherein the travel discovery and reservation computer is programmed to use a plurality of previously stored preference files associated with a group of customers to generate the set of predictors.

123. The system of claim 93, wherein the travel discovery and reservation computer is programmed to use the criteria provided by the customer to override the previously stored preference file of the customer.

124. The system of claim 93, wherein the travel discovery and reservation computer is programmed to additionally use a previously stored travel history of the customer to generate the set of predictors.

125. The system of claim 93 wherein the input controls comprise a slider control.

126. The system of claim 93 wherein the input controls comprise a plurality of radio buttons.

127. The system of claim 93 wherein the input controls comprise a plurality of check boxes.

128. The system of claim 95 wherein at least one of the travel service provider computers is a transportation provider computer, and wherein the travel offer received from the transportation provider computer specifies a travel segment that provides transportation that is responsive to the request by the travel discovery and reservation computer.

129. The system of claim 128 wherein the transportation provider computer is an airline flight reservation computer, and wherein the travel offer received from the airline flight reservation computer specifies a travel segment of an airline flight responsive to the request by the travel discovery and reservation computer.

130. The system of claim 128 wherein the transportation provider computer is an automobile rental reservation computer, and wherein the travel offer received from the automobile rental reservation computer specifies a travel segment of an automobile rental responsive to the request by the travel discovery and reservation computer.

131. The system of claim 95 wherein at least one of the travel service provider computers is a lodging service provider computer, and wherein the travel offer received from the lodging service provider computer specifies a travel segment that provides lodging that is responsive to the request by the travel discovery and reservation computer.

132. The system of claim 131 wherein the lodging service provider computer is a hotel reservation computer, and wherein the travel offer received from the hotel reservation computer specifies a travel segment of a hotel room reservation responsive to the request by the travel discovery and reservation computer.

133. The system of claim 95 wherein at least one of the travel service provider computers is a meal service provider computer, and wherein the travel offer received from the meal service provider computer specifies a travel segment that provides meals that is responsive to the request by the travel discovery and reservation computer.

134. The system of claim 95 wherein at least one of the travel service provider computers is an event service provider computer, and wherein the travel offer received from the event service provider computer specifies a travel segment of a reservation for an event responsive to the request by the travel discovery and reservation computer.

135. The system of claim 134 wherein the event service provider computer is a theme park reservation computer, and wherein the travel offer received from the theme park reservation computer specifies a travel segment of a theme park admission responsive to the request by the travel discovery and reservation computer.

136. The system of claim 134 wherein the event service provider computer is a theater reservation computer, and wherein the travel offer received from the theater reservation computer specifies a travel segment of a theater admission responsive to the request by the travel discovery and reservation computer.

137. The system of claim 134 wherein the event service provider computer is a sporting event service provider computer, and wherein the travel offer received from the sporting event service provider computer specifies a travel segment of a sporting event admission responsive to the request by the travel discovery and reservation computer.

138. The system of claim 134 wherein the event service provider computer is a tour group reservation computer, and wherein the travel offer received from the tour group reservation computer specifies a travel segment of a tour group admission responsive to the request by the travel discovery and reservation computer.

139. The system of claim 95 wherein at least one of the travel service provider computers is a third party aggregator reservation computer, and wherein the travel offer received from the third party aggregator reservation computer specifies any of the following: a travel segment of a transportation reservation responsive to the request by the travel discovery and reservation computer, a lodging reservation responsive to the request by the travel discovery and reservation computer, a meals reservation responsive to the request by the travel discovery and reservation computer, or an event reservation for an event responsive to the request by the travel discovery and reservation computer

140. A discovery and reservation computer for generating a master travel itinerary for a customer comprising communications circuitry for communicating via at least one network with a customer computer and with a plurality of travel service provider computers, and processing circuitry programmed to:
send to the customer computer a web page comprising a plurality of input controls for inputting a plurality of travel criteria,
receive from the customer computer a plurality of travel criteria input by a customer via the web page;
analyze the travel criteria provided by the customer computer to generate a set of predictors that recommend at least one proposed travel itinerary that satisfies the travel criteria;
generate a plurality of proposed travel segments, each of the proposed travel segments associated with a different part of the proposed travel itinerary,
send the proposed travel segments to the customer computer for acceptance or rejection by the customer;
receive an indication from the customer computer as to which of the proposed travel segments are accepted;
compile a master travel itinerary comprising the accepted travel segments, and
send the master travel itinerary to the customer computer.

141. The travel discovery and reservation computer of claim 140, wherein the processing circuitry is further programmed to, for each accepted travel segment, transmit to at least one travel service provider computer a request for a travel offer related to the accepted travel segment.

142. The travel discovery and reservation computer of claim 141, wherein the processing circuitry is further programmed to receive from each requested travel service provider computer a travel offer responsive to the request specifying a retail price normally charged for the accepted travel segment and a load factor associated with the accepted travel segment.

143. The travel discovery and reservation computer of claim 142, wherein the processing circuitry is further programmed to generate, for each received travel offer, a discounted travel offer having a discounted price less than the retail price normally charged for the accepted travel segment.

144. The travel discovery and reservation computer of claim 143, wherein the processing circuitry is programmed to generate, for each received travel offer, a discounted travel offer having a discounted price less than the retail price normally charged for the accepted travel segment by:
referencing a predetermined load factor discount rate table for the associated travel service provider computer to retrieve a predetermined discount for the associated load factor, and
applying the retrieved predetermined discount to the retail price to generate the discounted price.

145. The travel discovery and reservation computer of claim 143, wherein the processing circuitry is programmed to generate, for each received travel offer, a discounted travel offer having a discounted price less than the retail price normally charged for the accepted travel segment by:
transmitting, to the travel service provider computer that provided the travel offer, a request for a discount;
receiving a real-time discount from the travel service provider computer; and
applying the received real-time discount to the retail price to generate the discounted price.

146. The travel discovery and reservation computer of claim 143, wherein the processing circuitry is programmed to include at least one discounted travel offer for each accepted travel segment in the master travel itinerary sent to the customer computer.

147. The travel discovery and reservation computer of claim 146, wherein the processing circuitry is programmed to receive from the customer computer, for each accepted travel segment, an acceptance of a discounted travel offer associated with the accepted travel segment of the master travel itinerary.

148. The travel discovery and reservation computer of claim 147, wherein the processing circuitry is programmed to:
for each accepted segment offer, generate a proposed payment solution comprising a monetary portion and a promotional portion, the monetary portion payable by the customer with legal tender and the promotional portion payable by the customer with promotional currency; and
transmit the proposed itinerary payment solution to the customer computer for review by the customer.

149. The travel discovery and reservation computer of claim 148, wherein the processing circuitry is programmed to:
receive customer acceptance of the proposed payment solution, and
cause payment to be made in accordance with the monetary portion and the promotional portion of the proposed payment solution.

150. The travel discovery and reservation computer of claim 148, wherein the processing circuitry is programmed to:
receive from the customer computer a modified payment solution, and
cause payment to be made in accordance with the monetary portion and the promotional portion of the modified payment solution.

151. The travel discovery and reservation computer of claim 146, wherein the processing circuitry is programmed to:
receive from the customer computer a request for an alternate travel offers;
request alternate travel offers from associated travel service provider computers,
receive from each of the travel service provider computers an alternate travel offer,
generate, for each received alternate travel offer, a discounted alternate travel offer having a discounted price; and
present the discounted alternate travel offers to the customer computer.

152. The travel discovery and reservation computer of claim 146, wherein the processing circuitry is programmed to receive from the customer computer, for each accepted travel segment, a rejection of a discounted travel offer associated with the accepted travel segment of the master travel itinerary.

153. The travel discovery and reservation computer of claim 152, wherein the processing circuitry is programmed to
generate a counteroffer for the each of the rejected discounted travel offers; and
send the counteroffers to each of the associated travel service provider computers.

154. The travel discovery and reservation computer of claim 153, wherein the processing circuitry is programmed to
receive from each of the associated travel service provider computers an acceptance or rejection of the counteroffers generated by the processing circuitry, and send the accepted counteroffers to the customer computer.

155. The travel discovery and reservation computer of claim 152, wherein the processing circuitry is programmed to
receive from the customer a counteroffer for the each of the rejected segments of the discounted travel offers; and
send the counteroffers to each of the associated travel service provider computers.

156. The travel discovery and reservation computer of claim 155, wherein the processing circuitry is programmed to
receive from each of the associated travel service provider computers an acceptance or rejection of the counteroffers made by the customer, and
send the accepted counteroffers to the customer computer.

157. The travel discovery and reservation computer of claim 140, wherein the processing circuitry is programmed to, for each proposed travel segment, transmit to at least one travel service provider computer a request for a travel offer related to the proposed travel segment.

158. The travel discovery and reservation computer of claim 157, wherein the processing circuitry is programmed to receive from each requested travel service provider computer a travel offer responsive to the request specifying a retail price normally charged for the proposed travel segment and a load factor associated with the proposed travel segment.

159. The travel discovery and reservation computer of claim 158, wherein the processing circuitry is programmed to generate, for each received travel offer, a discounted travel offer having a discounted price less than the retail price normally charged for the proposed travel segment.

160. The travel discovery and reservation computer of claim 140, wherein the processing circuitry is programmed to
provide criteria modification input controls alongside the proposed travel segments at the customer computer,
receive modified or additional criteria from the criteria modification input controls at the customer computer,
generate a new set of proposed travel segments based on the modified or additional criteria, and
send the new set of proposed travel segments to the customer computer for acceptance or rejection by the customer.

161. The travel discovery and reservation computer of claim 140, wherein the processing circuitry is programmed to
provide keyword input controls alongside the proposed travel segments at the customer computer,
receive selected keyword inputs from the keyword input controls at the customer computer,
generate a new set of proposed travel segments based on the received keyword, and
send the new set of proposed travel segments to the customer computer for acceptance or rejection by the customer.

162. The travel discovery and reservation computer of claim 140, wherein the processing circuitry is programmed to receive from the customer computer a request for an alternate master travel itinerary, and send an alternate set of proposed travel segments to the customer computer for acceptance or rejection by the customer.

163. The travel discovery and reservation computer of claim 140, wherein the processing circuitry is programmed to store in memory one or more master travel itineraries for subsequent retrieval and review by the customer.

164. The travel discovery and reservation computer of claim 140, wherein the processing circuitry is programmed to receive from the customer computer a selection of proposed segments of the master travel itinerary in which the customer has indicated an interest.

165. The travel discovery and reservation computer of claim 164, wherein the processing circuitry is programmed to provide a shuffle control to the customer computer enabling the customer to retrieve additional or replacement proposed segments to supplement the selection of proposed segments in which the customer has indicated an interest.

166. The travel discovery and reservation computer of claim 140, wherein the processing circuitry is programmed to additionally use previously stored preferences of the customer to generate the set of predictors.

167. The travel discovery and reservation computer of claim 166, wherein the processing circuitry is programmed to store the preferences provided by the customer computer during a registration process.

168. The travel discovery and reservation computer of claim 166, wherein the processing circuitry is programmed to determined the preferences by analyzing previously entered travel criteria.

169. The travel discovery and reservation computer of claim 166, wherein the processing circuitry is programmed to obtain the preferences from external sources.

170. The travel discovery and reservation computer of claim 140, wherein the processing circuitry is programmed to use a plurality of previously stored preference files associated with a group of customers to generate the set of predictors.

171. The travel discovery and reservation computer of claim 140, wherein the processing circuitry is programmed to use the criteria provided by the customer to override the previously stored preference file of the customer.

172. The travel discovery and reservation computer of claim 140, wherein the processing circuitry is programmed to additionally use a previously stored travel history of the customer to generate the set of predictors.

173. The travel discovery and reservation computer of claim 140 wherein the input controls comprise a slider control.

174. The travel discovery and reservation computer of claim 140 wherein the input controls comprise a plurality of radio buttons.

175. The travel discovery and reservation computer of claim 140 wherein the input controls comprise a plurality of check boxes.
